(19) United States
(12) Patent Application Publication
(10) Pub. No.: US 2012/0166790 A1
(43) Pub. Date: Jun. 28, 2012

(54) INFORMATION PROCESSING APPARATUS, STORAGE MEDIUM AND INFORMATION PROCESSING METHOD

(75) Inventors: Hirotake KITASE, Kyoto (JP); Yoichi OSHIMA, Kyoto (JP)

(73) Assignee: NINTENDO CO., LTD., Kyoto (JP)

(21) Appl. No.: 13/052,568

(22) Filed: Mar. 21, 2011

(30) Foreign Application Priority Data
Dec. 28, 2010 (JP) 2010-291497

(51) Int. Cl. G06F 9/00

(52) U.S. Cl. 713/100

(57) ABSTRACT

A game apparatus as an information processing apparatus includes a CPU, and the CPU counts step counts on the basis of an acceleration signal from an acceleration sensor when cover closing information is received from a microcomputer in a state that the power source is turned on. Step count data corresponding to the step counts is stored in a memory within the microcomputer in a cluster for every first predetermined time (one hour). Furthermore, in a case that a first mode is set in a state that the power source of the game apparatus is turned on, the step count data stored in the memory is automatically saved in a NAND-type flash memory every time that a second predetermined time has elapsed before the first mode switches to a second mode, or before the power source of the game apparatus is turned off.

### CROSS REFERENCE OF RELATED APPLICATION

The disclosure of Japanese Patent Application No. 2010-291497 filed on Dec. 28, 2010 is incorporated herein by reference.

### BACKGROUND OF THE INVENTION

1. Field of the Invention

The present invention relates to an information processing apparatus, a storage medium and an information processing method. More specifically, the present invention relates to an information processing apparatus, a storage medium and an information processing method that count and store step counts.

2. Description of the Related Art

One example of an information processing apparatus of such a kind is disclosed in Japanese Patent Application Laid-Open No. 2005-237926 [A43B 23/00, A63B 23/04, GO1C 22/00] (document 1) laid-open on Sep. 8, 2005. As to shoes having a function of recording exercise information of this document 1, it is disclosed that the recorded exercise information is transferred to a personal computer or the like by a communicator, and an exercise history is displayed and managed for a long time.

Furthermore, another example of an information processing apparatus of such a kind is disclosed Japanese Patent Application Laid-Open No. 2010-9328 [GO6M 3/00, A63B 23/04, A63B 71/06, A63B 69/00] (document 2) laid-open on Jan. 14, 2010. In a step count counting system of the document 2, it is disclosed that by pushing a push button of a pedometer, a communication with a step count managing apparatus is started, so that step counts detected and recorded by the pedometer can be transmitted to the step count managing apparatus.

However, in the document 1 and the document 2, the step counts detected and recorded by the pedometer are transmitted to another apparatus different from the pedometer to thereby manage the step counts, so that such the other apparatus has to be prepared. Furthermore, an operation of transmitting the step counts from the pedometer to the other apparatus is required. In addition, it is conceivable that a user may not perform such the operation, and therefore, recording and managing the step counts for a long time may not be properly performed.

### SUMMARY OF THE INVENTION

Therefore, it is a primary object of the present invention to provide a novel information processing apparatus, a novel storage medium and a novel information processing method for saving step counts for a long time.

A first invention is an information processing apparatus comprising a step count detector, a step count storage, and a saver. The step count detector detects step counts. The step count storage stores step count data corresponding to the step counts detected by the step count detector in a first memory. The saver automatically reads the step count data stored in the first memory at a predetermined timing and saves the same in a second memory different from the first memory.

According to the first invention, the step count data stored in the first memory is automatically saved in the second memory at the predetermined timing, and therefore, it is possible to simply and easily implement saving of the step counts for a long time without the need of any operation.

A second invention is according to the first invention, and further comprises a state switcher. The state switcher switches the information processing apparatus between an unused state and a used state. The step count detector detects step counts at least in the unused state. The saver automatically reads the step count data stored in the first memory at the predetermined timing and saves the same in the second memory at least in the unused state.

According to the second invention, in the unused state of the information processing apparatus, the step counts are detected, and the step count data is saved at the predetermined timing, and therefore, it is possible to save the step counts for a long time without making the user aware of it.

A third invention is according to the second invention, wherein the step count detector detects step counts in the unused state, and does not detect step counts in the used state.

According to the third invention, the step counts are detected in the unused state, so that the information processing apparatus can be worked as a pedometer when it is not used.

A fourth invention is according to the second invention, wherein the state switcher switches between a power saving mode and a normal mode. The step count detector detects step counts at least in the power saving mode. The saver automatically reads the step count data stored in the first memory and saves the same in the second memory after a temporary switch to the normal mode at a predetermined timing during the power saving mode.

According to the fourth invention, during the power saving mode, the step counts are stored, and after a temporary switch to the normal mode is made at the predetermined timing, the step count data is saved. Thus, it is possible to save the step counts for a long time without making the user aware of it, and moreover, it is possible to reduce electric power consumption required for saving.

A fifth invention is according to the fourth invention, wherein the step count detector detects step counts in the power saving mode, and does not detects step counts in the normal mode.

According to the fifth invention, it is possible to make the information processing apparatus work as a pedometer in the power saving mode.

A sixth invention is according to the fourth invention, wherein the saver automatically reads the step count data stored in the first memory at the predetermined timing and saves the same in the second memory in the normal mode.

According to the sixth invention, it is possible to save the step counts detected in the power saving mode in the second memory at the predetermined timing in the normal mode.

A seventh invention is according to the second invention, wherein the state switcher switches the saver between an activated state and an inactivated state. The step count detector detects step counts when the saver is in the inactivated state. The saver automatically reads the step count data stored in the first memory and saves the same in the second memory after a temporary switch to the activated state by the state switcher at the predetermined timing during the inactivated state.

According to the seventh invention, the step counts are detected while the function of saving the step count data is inactivated. After the function of saving the step count data is temporarily activated at the predetermined timing, the step count data is saved. Thus, it is possible to save the step counts for a long time without making the user aware of it, and moreover, it is possible to reduce the electric power supplied to the function of saving the step counts.

An eighth invention is according to the seventh invention, wherein the step count detector detects steps counts when the saver is in the inactivated state, and does not detect step counts when the saver is in the activated state.

According to the eighth invention, when the saver is in the inactivated state, it is possible to make the information processing apparatus work as a pedometer.

A ninth invention is according to the seventh invention, wherein the saver automatically reads the step count data stored in the first memory at the predetermined timing and saves the same in the second memory when it is in the activated state.

According to the ninth invention, it is possible to save the step counts that are detected in the inactivated state in the second memory at the predetermined timing in the activated state.

A tenth invention is according to the first invention, wherein the predetermined timing is every lapse of a predetermined time.

According to the tenth invention, the step count data is saved at a timing when the predetermined time has elapsed, and therefore, it is possible to more surely and periodically save the step counts for a long time.

An eleventh invention is according to the tenth invention, wherein a first predetermined timing is when the predetermined time has elapsed from a time being a reference. For example, the time being the reference is equivalent to a time when the information processing apparatus is booted or rebooted, or a time when the information processing apparatus is slept.

According to the eleventh invention, it is possible to save the step count data stored in the first memory in the second memory every time that the predetermined time has elapsed from the time being a reference.

A twelfth invention is according to the tenth invention, further comprising a selector. The selector selects between a power-off or a reboot. The predetermined timing is a timing when a power-off or a reboot is selected by the selector.

According to the twelfth invention, it is possible to surely save the step counts when the information processing apparatus is ended or rebooted.

A thirteenth invention is according to the first invention, wherein the first memory has a memory area for storing step count data for a short time. On the other hand, the second memory has a memory area of a high capacity capable of recording step count data for a longer time than the memory area of the first memory.

According to the thirteenth invention, the first memory and the second memory having different capacities are provided, and therefore, it is possible to shift from storing the step count for a short time to saving it for a long time within a single information processing apparatus.

A fourteenth invention is according to the first invention, and the information processing apparatus further comprises: a mode switcher which switches a first mode for executing a program for the information processing apparatus and a second mode for executing a program for another information processing apparatus. The saver automatically reads the step count data stored in the first memory at the predetermined timing and saves the same in the second memory in the first mode, and does not save the step count data stored in the first memory in the second memory in the second mode.

According to the fourteenth invention, in the information processing apparatus operated in the first mode or the second mode, it is possible to save the step count data in the second memory at the predetermined timing in the first mode.

A fifteenth invention is according to the fourteenth invention, wherein said saver saves step count data that is stored in the first memory in the second mode in the second memory at the predetermined timing after the second mode switches to the first mode by the mode switcher.

According to the fifteenth invention, it is possible to save the step count data corresponding to the step counts that are detected in the second mode in the second memory at the predetermined timing after a switch to the first mode is made. Accordingly, it becomes possible to save and manage the step counts for a long time.

A sixteenth invention is a storage medium storing an information processing program, the information processing program causes a computer to function as a step count detector, a step count storage, and a saver. The step count detector detects step counts. The step count storage stores step count data corresponding to the step counts detected by the step count detector in a first memory. The saver automatically reads the step count data stored in the first memory at a predetermined timing and saves the same in a second memory different from the first memory.

A seventeenth invention is an information processing method, wherein a computer (a) detects step counts, (b) stores step count data corresponding to the step counts detected by the step (a) in a first memory, and (c) automatically reads the step count data stored in the first memory at a predetermined timing and saves the same in a second memory different from the first memory.

An eighteenth invention is an information processing apparatus, comprising: a microcomputer which detects step counts and stores step count data corresponding to the detected step counts in a first memory; and a CPU which reads the step count data stored in the first memory and saves the same in a second memory different from the first memory; wherein the CPU automatically reads the step count data stored in the first memory at a predetermined timing and saves the same in the second memory and stops in response to a request from the microcomputer during running, and boots up in response to a request from the microcomputer, reads the step count data stored in the first memory and saves the same in the second memory during a stop.

A nineteenth invention is an information processing method of an information processing apparatus, comprising: a microcomputer which detects step counts and stores step count data corresponding to the detected step counts in a first memory; and a CPU which reads the step count data stored in the first memory and saves the same in a second memory different from the first memory; wherein the CPU automatically reads the step count data stored in the first memory at a predetermined timing and saves the same in the second memory and stops in response to a request from the microcomputer during running, and boots up in response to a request from the microcomputer, reads the step count data stored in the first memory and saves the same in the second memory during a stop.

In the sixteenth to nineteenth inventions as well, similar to the first invention, it is possible to easily and simply implement saving for a long time.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing an external view of a game apparatus of one embodiment of the present invention, and shows a front surface in an opened state;

FIG. 2 is an external view of the game apparatus, FIG. 2(A) shows a top surface in a closed state, FIG. 2(B) shows a left side surface in the closed state, FIG. 2(C) shows a front surface in the closed state, FIG. 2(D) shows a right side surface in the closed state, FIG. 2(E) shows a back surface in the closed state, and FIG. 2(F) shows a bottom surface in the closed state;

FIG. 3 is an illustrative view illustrating an operation of a 3D adjusting switch;

FIG. 4 is a block diagram showing one example of an electric configuration of the game apparatus;

FIG. 5 is a block diagram showing an important part of an electric configuration in FIG. 4 (stereoscopic LCD controller being made up of a stereoscopic LCD and a part of SoC);

FIG. 6 is an illustrative view for explaining a principle of 3D/2D display in a parallax barrier method, FIG. 6(A) shows a state that a parallax barrier is turned on (3D display), and FIG. 6(B) shows a state that a parallax barrier is turned off (2D display);

FIG. 7 is an illustrative view showing a situation in which an object is imaged by right and left two virtual cameras in a virtual space;

FIG. 8 is an illustrative view showing an imaged image (the distance-between cameras is a maximum value D0) by the two virtual cameras, FIG. 8(A) shows a left image of a VRAM, FIG. 8(B) shows a right image of the VRAM, and FIG. 8(C) shows a stereoscopic image (3D is maximum) on an upper LCD;

FIG. 9 is an illustrative view explaining a change of a stereoscopic image according to a distance-between cameras, FIG. 9(A) shows one example of the distance-between cameras (0.5×D0), and FIG. 9(B) shows a stereoscopic image corresponding to the relevant distance(3D is middle);

FIG. 10 is an illustrative view explaining a 3D adjustment according to the distance-between cameras, FIG. 10(A) shows another example of the distance-between cameras (minimum value 0), and FIG. 10(B) shows a stereoscopic image corresponding to the relevant distance (3D is minimum=2D);

FIG. 11 is an illustrative view showing a memory map of a main memory shown in FIG. 4;

FIG. 12 is an illustrative view showing a memory map of a memory provided within a microcomputer shown in FIG. 4;

FIG. 13 is a flowchart showing a first part of entire processing by the CPU shown in FIG. 4;

FIG. 14 is a flowchart showing a second part of the entire processing by the CPU shown in FIG. 4 and being sequel to FIG. 13;

FIG. 15 is a flowchart showing a third part of the entire processing by the CPU shown in FIG. 4 and being sequel to FIG. 14;

FIG. 16 is a flowchart showing a fourth part of the entire processing by the CPU shown in FIG. 4 and being sequel to FIG. 13;

FIG. 17 is a flowchart showing a fifth part of the entire processing by the CPU shown in FIG. 4 and being sequel to FIG. 16;

FIG. 18 is a flowchart showing step count saving processing by the CPU shown in FIG. 4;

FIG. 19 is a flowchart showing a first part of the entire processing by a microcomputer shown in FIG. 4;

FIG. 20 is a flowchart showing a second part of the entire processing by the microcomputer shown in FIG. 4 and being sequel to FIG. 19;

FIG. 21 is a flowchart showing a third part of the entire processing by the microcomputer shown in FIG. 4 and being sequel to FIG. 20;

FIG. 22 is a flowchart showing a fourth part of the entire processing by the microcomputer shown in FIG. 4 and being sequel to FIG. 21;

FIG. 23 is a flowchart showing a fifth part of the entire processing by the microcomputer shown in FIG. 4 being sequel to FIG. 19; and

FIG. 24 is a flowchart showing step count counting processing by the microcomputer shown in FIG. 4.

### DETAILED DESCRIPTION OF THE PREFERRED EMBODIMENTS

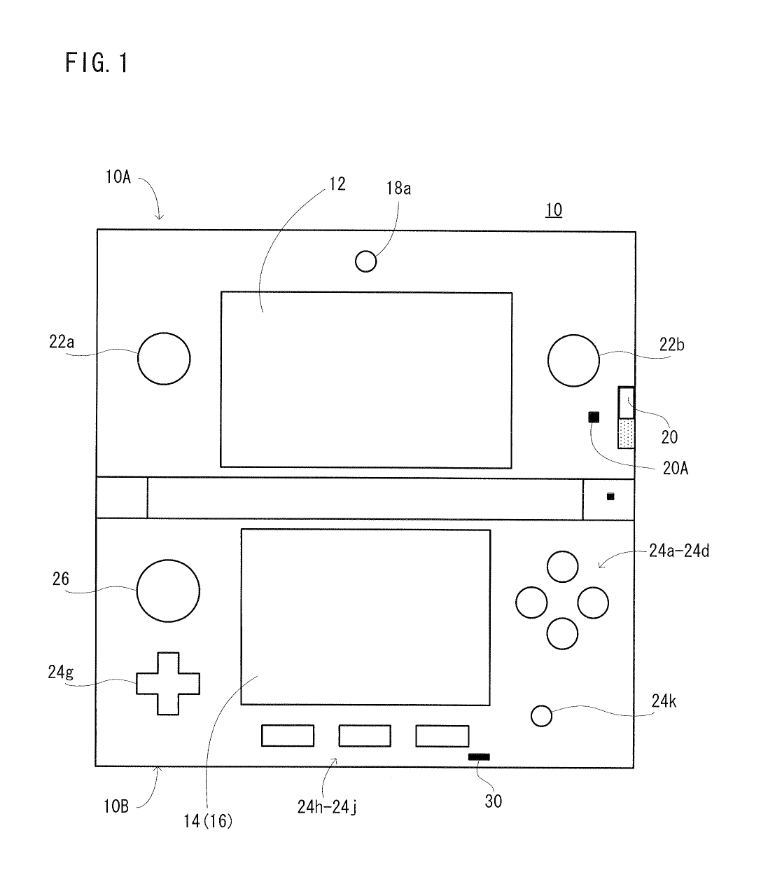

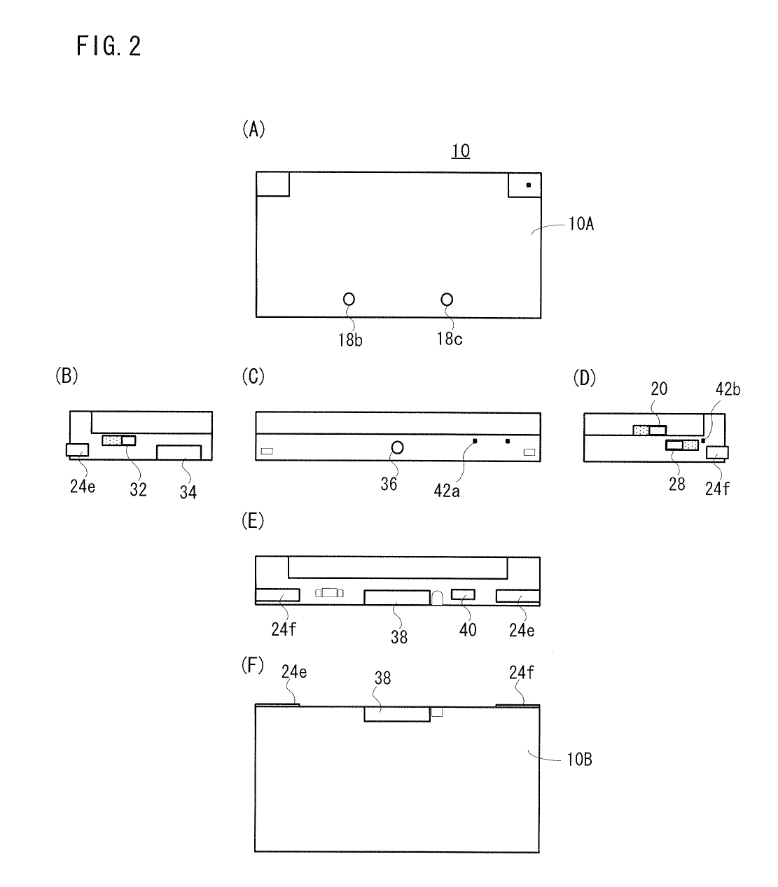

FIG. 1 and FIG. 2 show an appearance of the game apparatus 10 being one embodiment of the present invention. The game apparatus 10 is a foldable game apparatus, FIG. 1 shows a front of the game apparatus 10 in an opened state, FIG. 2 (A) to FIG. 2 (F) respectively shows a top surface, a left side surface, a front surface, a right side surface, a back surface and a bottom surface of the game apparatus 10 in a closed state.

The game apparatus 10 has an upper housing 10A and a lower housing 10B rotatably connected with each other as shown in FIG. 1, and on a top surface of the upper housing 10A, a stereoscopic LCD 12 compliant with an autostereoscopic display, an inward camera 18a, a 3D adjusting switch 20, a 3D lamp 20A, right and left speakers 22a and 22b, etc. are provided. On a top surface of the lower housing 10B, a lower LCD 14 attached with touch panel 16, A, B, X, Y buttons 24a-24d, a cross key (button)24g, home, select, start buttons 24h-24j, a power button 24k, an analog pad 26, and a microphone 30 are provided.

Furthermore, as shown in FIG. 2 (A), on the top surface of the game apparatus 10 (reverse side of the upper housing 10A shown in FIG. 1), right and left outward cameras 18b and 18c compliant with 3D imaging are provided. Furthermore, as shown in FIG. 2 (C), on the front surface of the game apparatus 10, a headphone terminal 36, a power lamp 42a, etc. are provided. Also, as shown in FIG. 2 (B), FIG. 2 (E) and FIG. 2 (D), from the left side surface to the back surface of the game apparatus 10, an L button 24e is provided, and from the right side surface to the back surface, an R button 24f is provided. Moreover, on the left side surface of the game apparatus 10, a volume control switch 32, an SD card slot 34, etc. are provided, and on the right side surface of the game apparatus 10, a wireless switch 28, a wireless lamp 42b, etc. are further provided. The above-described 3D adjusting switch 20 is exposed from the right side surface. In addition, on the back surface of the game apparatus 10, an infrared ray emitting-receiving portion 40, etc. is further provided. Then, as shown in FIG. 2 (E) and FIG. 2 (F), from the back surface to a bottom surface, a game card slot 38 is provided.

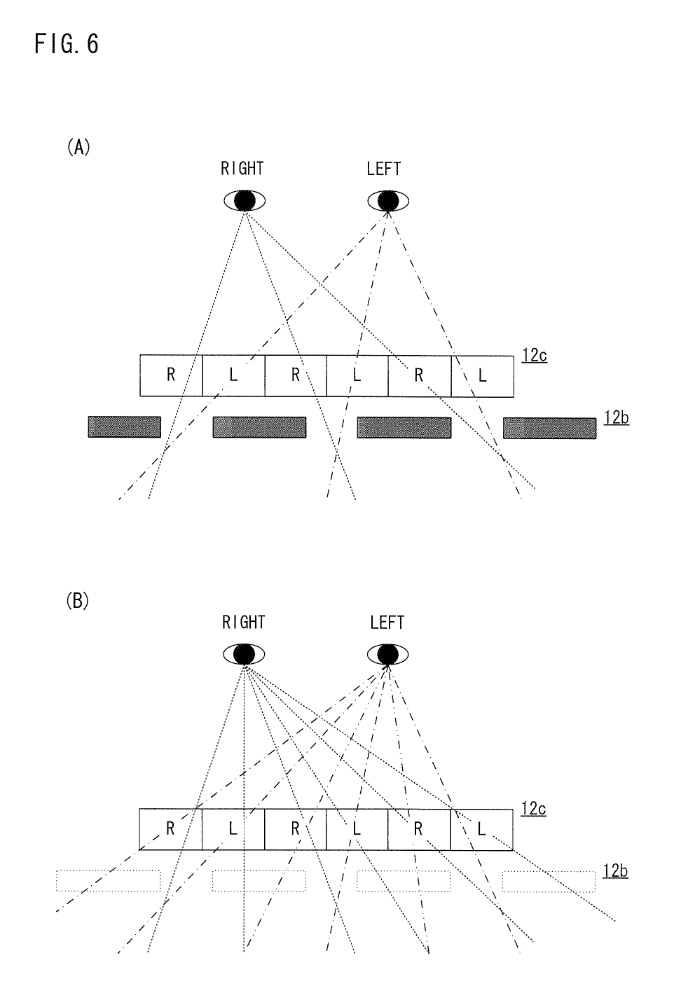

The stereoscopic LCD 12 is a 3D liquid crystal (see FIG. 6) according to a parallax barrier system, and displays a stereoscopic image without any glasses (autostereoscopic image). On the stereoscopic LCD 12, by turning a parallax barrier of the liquid crystal off, a planar image display is also made possible. It should be noted that a lenticular system utilizing a sheet with concaves/convexes (lenticular lens) and other autostereoscopic 3D systems may be adopted without being restricted to the parallax barrier system.

The inward camera 18a images a planar image (2D image) while the outward cameras 18b and 18c image stereoscopic images (3D image). A 2D or 3D image imaging the player can be used as an image input to an application program such as a game program. In this case, the game program detects movements of a face, a hand and a gazing direction (direction of eyeballs) of the player by performing image recognition, and executes processing corresponding to the detection result. The 2D image by the inward camera 18a can be displayed on the lower LCD 14, and the 3D images by the outward cameras 18b and 18c can be displayed on the stereoscopic LCD 12.

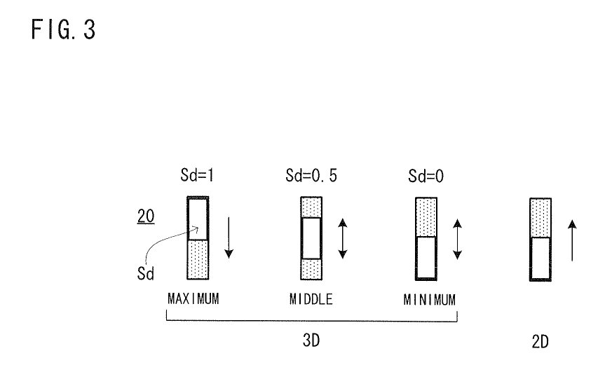

The 3D adjusting switch 20 manually switches the display of the stereoscopic LCD 12 between the 3D display and the 2D display, and is a slide switch for manually adjusting a three-dimensional effect in the 3D display as well and operates as shown in FIG. 3, for example. The three-dimensional effect of the 3D display becomes a maximum (Sd=1) when the slider Sd is at an upper end, decrease as the slider Sd is moved down, and becomes a minimum (Sd=0) when at a lower end in this embodiment. Then, the 3D display changes to the 2D display when the slider Sd is moved down.

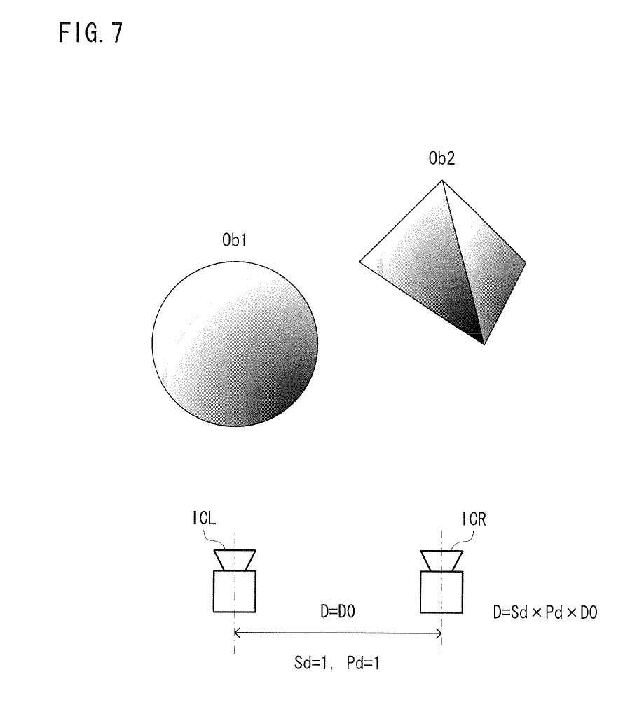

Although the detailed description is made later, such a change of the three-dimensional effect of the 3D display is implemented by changing the distance (distance-between cameras D) between the right and left virtual cameras (ICL and ICR: see FIG. 7) arranged within the virtual space (see FIG. 7-FIG. 10). That is, according to an operation of the 3D adjusting switch 20, the distance-between cameras D is adjusted. Then, the distance-between cameras D undergoes an automatic adjustment (described later) by the game program as well as the manual adjustment.

The 3D lamp 20A is a lamp showing a displaying condition of the stereoscopic LCD 12, and lights up in the 3D display and light off in the 2D display. Here, it may be changed in brightness and color in correspondence with the degree of the 3D display (intensity of the three-dimensional effect) as well as it merely lights up and off.

An operation to the touch panel 16, the A, B, X, Y buttons 24a-24d, the cross key (button) 24g, the home, select, start buttons 24h-24j, or the analog pad 26 is used as a touch/button/pad input to the game program. The power button 24k is used for turning on or off the power of the game apparatus 10. The power lamp 42a lights up or off in conjunction with the power-on or the power-off of the power source.

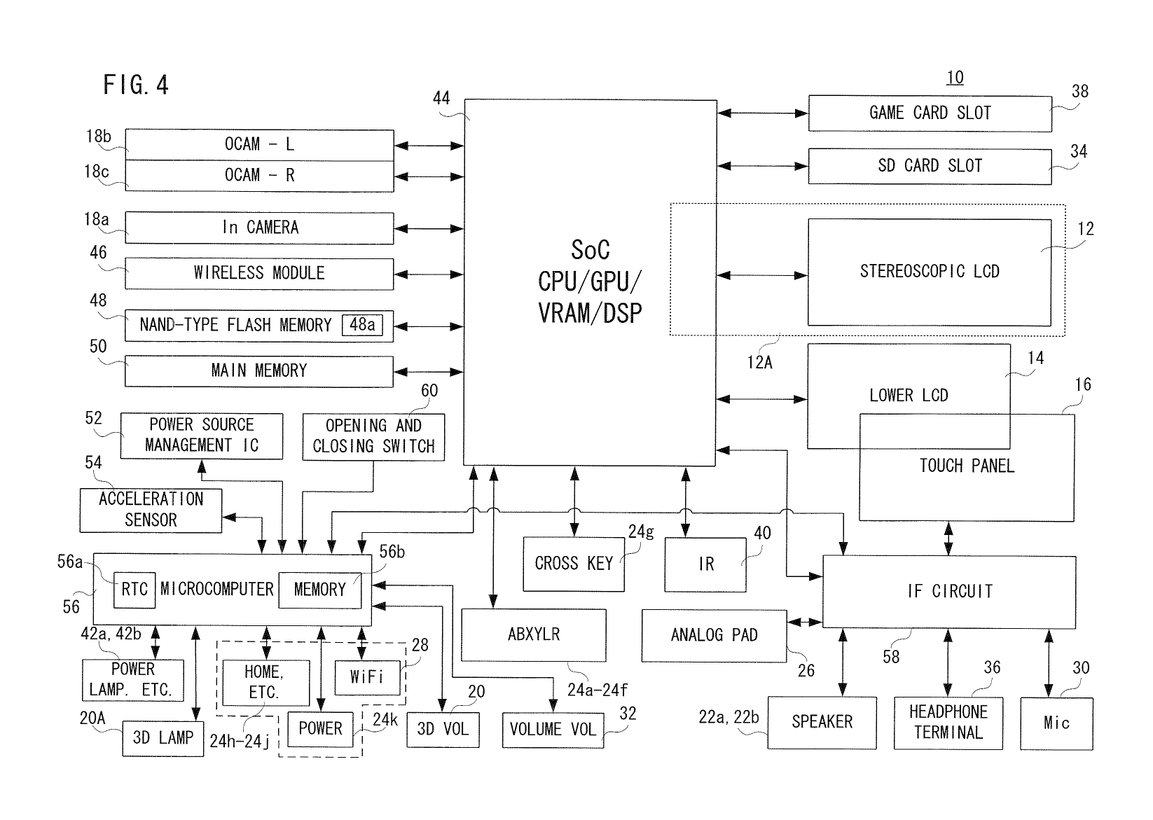

The microphone 30 converts a speech voice by a player, an environmental sound, etc. into sound data. The sound data can be used as a sound input to the game program. In this case, the game program detects the speech voice by the player by performing voice recognition, and executes processing according to the detection result. The sound data by the microphone 30 can be further recorded in a NAND-type flash memory 48 (see FIG. 4), etc.

The speakers 22a and 22b output a game voice, a microphone voice, etc. To the headphone terminal 36, a headphone not shown is connected. The volume control switch 32 is a slide switch for adjusting volumes of the speakers 22a and 22b or an output from the headphone terminal 36.

The SD card slot 34 is attached with an SD memory card (not illustrated) for saving a camera image, a microphone sound, etc., and the game card slot 38 is attached with a game card (not illustrated) storing the game program, etc. The infrared ray emitting-receiving portion 40 is utilized for infrared rays (IR) communications with other game apparatuses.

FIG. 4 shows an electric configuration of the game apparatus 10. The game apparatus 10 includes an SoC (System-on-a-Chip) 44 being made up of a CPU, a GPU, a VRAM, a DSP, etc. The SoC 44 is connected with the above-described stereoscopic LCD 12, lower LCD 14, inward camera (In camera) 18a, right and left outward cameras (OCAM-L and OCAM-R) 18b and 18c, A, B, X, Y, L, R buttons 24a-24f, cross button 24g, SD card slot 34, game card slot 38, and infrared ray emitting-receiving portion (IR) 40. The SoC 44 is further connected with the above-described 3D adjusting switch (3D Vol) 20, 3D lamp 20A, home, select, start buttons 24h-24j, power button (Power) 24k, wireless switch (WiFi) 28, volume control switch (volume Vol) 32, and power, wireless lamps 42a, 42b via a microcomputer (hereinafter referred to as “micon”) 56. The SoC 44 is moreover connected with the above-described touch panel 16, right and left speakers 22a and 22b, analog pad 26, microphone (Mic) 30 and headphone terminal 36 via an IF circuit 58.

In addition, the SoC 44 is connected with a wireless module 46, the NAND-type flash memory 48 and a main memory 50 as elements other than the above description. The wireless module 46 has a function of connecting to a wireless LAN. The NAND-type flash memory 48 stores data to be saved, such as a camera image, a microphone voice, etc. The main memory 50 gives a working area to the SoC 44. That is, in the main memory 50, various data and programs to be used in the application such as a game are stored, and the SoC 44 performs works by utilizing the data and program stored in the main memory 50.

The microcomputer 56 is connected with a power source management IC 52 and an acceleration sensor 54. The power source management IC 52 performs a power source management of the game apparatus 10, and selectively supplies or stops electric power from a power source (battery) not shown to each of the components of the game apparatus 10. Furthermore, the acceleration sensor 54 is a three-axis acceleration sensor, and provided inside the lower housing 10B (this may be provided inside the upper housing 10A). It detects an acceleration in a direction vertical to the surface of the stereoscopic LCD 12 (lower LCD 14) of the game apparatus 10, and detects accelerations in a direction parallel with the surface of the stereoscopic LCD 12 (lower LCD 14), that is, accelerations in the two directions (longitudinal and lateral) that are orthogonal to each other are detected. The acceleration sensor 54 outputs a signal (acceleration signal) as to the detected accelerations to the microcomputer 56. The microcomputer 56 can detect the direction of the game apparatus 10 on the basis of the acceleration signal, and can detect the magnitude of the shake of the game apparatus 10. For example, the detection result of the acceleration sensor 54 can be used as a motion input to the application program, such as the game program, etc. In this case, the application program calculates the movement of the game apparatus 10 itself on the basis of the detection result, and executes the processing according to the result of the calculation.

Furthermore, the microcomputer 56 includes an RTC (real-time clock) 56a and a memory 56b. The microcomputer 56 supplies the time counted by the RTC 56a to the SoC 44. The memory 56b is a memory, such as a RAM and a flash memory, in which programs and various data to be executed by the microcomputer 56 are stored.

Additionally, from an opening and closing switch 60, an ON or Off signal is applied to the microcomputer 56. In a case that the power source of the game apparatus 10 is turned on in a state that the opening and closing switch 60 is turned on, that is, in a state that the main body of the game apparatus 10 itself or the cover (upper housing 10A) of the game apparatus 10 is opened, a mode in which electric power is supplied to all the components of the game apparatus 10 by the power source management IC 52 under the control of the microcomputer 56 (hereinafter referred to as, “normal mode”) is set. The normal mode is a state in which the game apparatus 10 can execute an arbitrary application, and the user or the player is using the game apparatus 10 (used state).

Furthermore, in a case that the power source of the game apparatus 10 is turned on in a state that the opening and closing switch 60 is turned off, that is, in a state that the main body of the game apparatus 10 itself or the cover of the game apparatus 10 is closed, a mode in which electric power is supplied from the power source management IC 52 to a part of the components of the game apparatus 10 (hereinafter referred to as “sleep mode”) is set. Here, depending on the kind of the application and the situation of the execution (proceeding) of the application, the sleep mode may not be set. Whether to execute the sleep or not is determined by the CPU 44a, and when execution of the sleep is determined, the CPU 44a instructs the microcomputer 56 to execute the sleep. Furthermore, even if the sleep is not executed, the power source of the stereoscopic LCD 12 and the lower LCD14 are turned off in the closed state. Accordingly, the closed state can be referred to as “power-saving mode” for reducing the electric power supply.

The sleep mode or the closed state is a state in which the game apparatus 10 cannot execute an arbitrary application in principle, and the user or the player is not using the game apparatus 10 (unused state). In this embodiment, the parts of the components are the CPU 44a, the wireless module 46, the power source management IC 52 and the microcomputer 56. Here, in the sleep mode (sleep state), the CPU 44a is basically in a state that the clock is stopped (inactivated), resulting in less power consumption. Or, in the sleep mode, the power supply to the CPU 44a may be stopped. Accordingly, as described above, in this embodiment, in the sleep mode, the application is never executed by the CPU 44a.

Here, the power source management IC 52 and the microcomputer 56 are supplied with electric power in a case that the power source of the game apparatus 10 is turned off as well.

Furthermore, in the sleep state, as described above, the CPU 44a is in an inactivated state, and the wireless module 46 transmits and receives a connection request/response signal (beacon) for searching other apparatuses. Then, when another appliance that meets the condition is found by the search, in response to a control signal from the wireless communication module 46, the CPU 44a is activated. That is, by the wireless module 46, the clock of the CPU 44a is operated, and the wireless module 46 applies a communication starting instruction to the CPU 44a. This holds true hereunder. Then, the CPU 44a instructs the microcomputer 56 to start supplying electric power to the NAND-type flash memory 48. Accordingly, by a communication (in-passing communication), the data stored in the NAND-type flash memory 48 can be transmitted to other game apparatuses, computers or access points (corresponding to the aforementioned “other appliances”), and the data received from other appliances can be saved in the NAND-type flash memory 48.

In addition, when the cover of the game apparatus 10 is opened, an ON signal is input from the opening and closing switch 60 to the microcomputer 56. In a case that the game apparatus 10 is in the sleep state here, the microcomputer 56 cancels the sleep. More specifically, the microcomputer 56 boots up the CPU 44a and controls the power source management IC 52 to thereby supply electric power to all of the components. Accordingly, the game apparatus 10 shifts to the normal mode and in the used state. In addition, the microcomputer 56 instructs the CPU 44a to cancel the sleep. Accordingly, in a case that the processing of the application, etc. was suspended, the CPU 44a restarts the suspended processing in response to an instruction of cancelling the sleep. Here, when the cover of the game apparatus 10 is opened, in a case that the game apparatus 10 is not in the sleep state, the microcomputer 56 controls the power source management IC 52 under the instruction of the CPU 44a to supply electric power to the stereoscopic LCD 12 and the lower LCD 14.

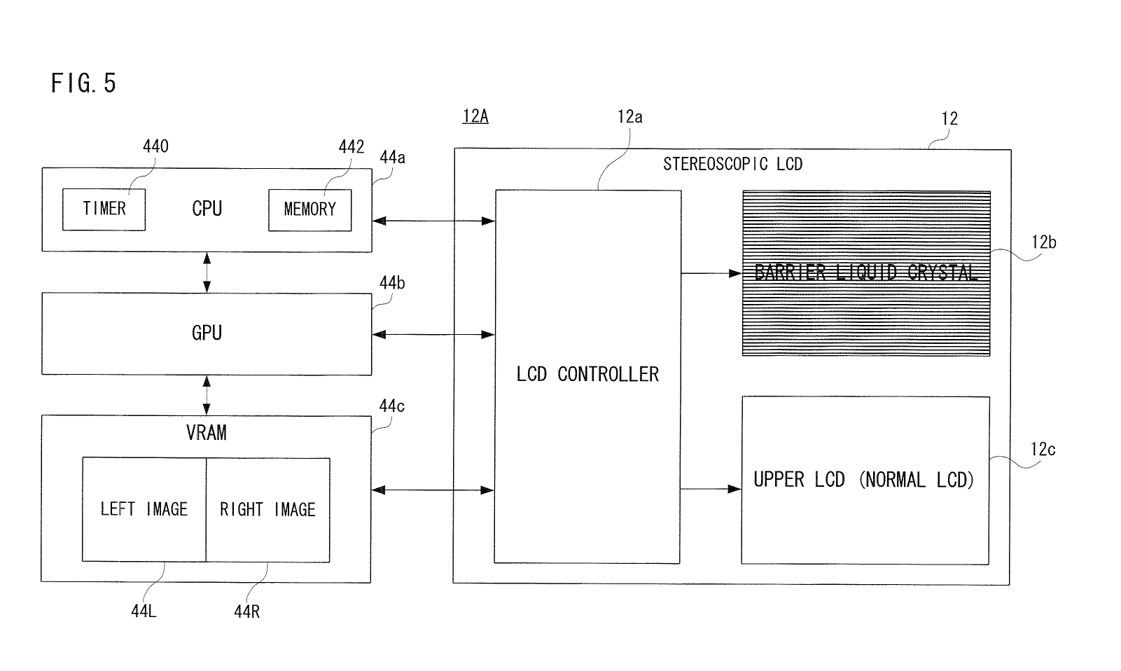

FIG. 5 shows a stereoscopic LCD controller 12A being made up of the stereoscopic LCD 12 and a part of the SoC 44. The stereoscopic LCD 12 includes an LCD controller 12a, a barrier liquid crystal 12b and an upper LCD 12c. The barrier liquid crystal 12b includes a plurality of liquid crystal slits extending in a vertical (row) direction as shown in FIG. 6(A), and makes the right eye and the left eye view beams passing through pixels in a different row of the upper LCD 12c by alternately cutting off the beam from the backlight by the plurality of liquid crystal slits. The upper LCD 12c may be a general liquid crystal (for 2D display) similar to the lower LCD 14. The LCD controller 12a performs drawing on the upper LCD 12c under the control of the GPU 44b and then the CPU 44a, and turns the barrier liquid crystal 12b (applied voltage) on and off. When the barrier liquid crystal 12b is turned off, the right eye and the left eye can view the beams passing through the pixels of all the rows on the upper LCD 12c as shown in FIG. 6(B).

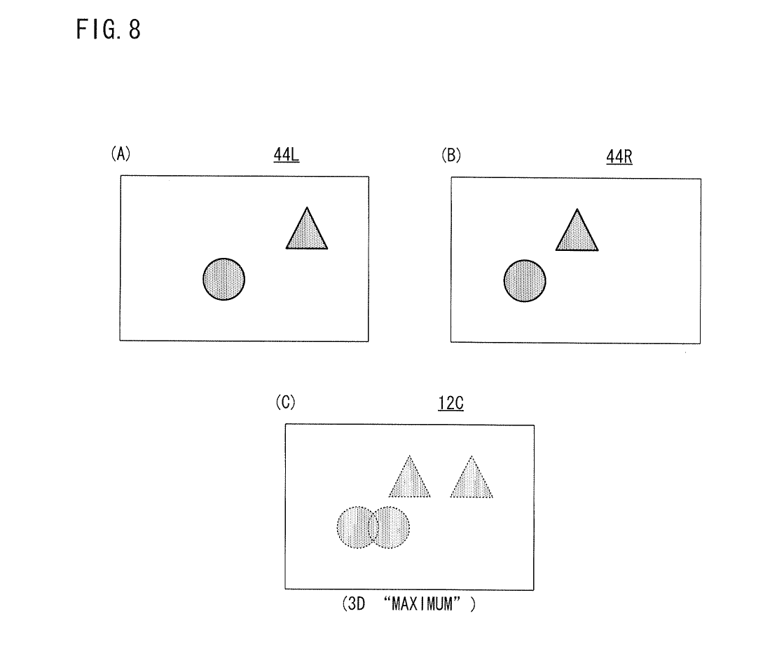

More specifically, as shown in FIG. 7, in a case that objects Ob1 and Ob2 are imaged by a left virtual camera ICL and a right virtual camera ICR spacedly arranged right and left (D=D0) within the virtual space, the GPU 44b writes a left image 44L and a right image 44R as shown in FIG. 8(A) and FIG. 8(B) to the VRAM 44c, and the LCD controller 12a alternately reads the left image 44L and the right image 44R stored in the VRAM 44c on a row-by-row basis, and draws them in the upper LCD 12c in order under the control of the CPU 44a. Thus, on the upper LCD 12c, a stereoscopic image (for implementing a stereoscopic views) as shown in FIG. 8(C) is displayed. When a backlight beam to the stereoscopic image is limited by the barrier liquid crystal 12b, the left eye can view the left image 44L as shown in FIG. 8(A), and the right eye can view the right image 44R as shown in FIG. 8(B), so that autostereoscopy is implemented.

Here, FIG. 5 shows that the LCD controller 12a, the GPU 44b and the VRAM 44c are provided by bringing them into correspondence with the stereoscopic LCD 12, and naturally, the LCD controller, the GPU and the VRAM are also provided bringing them into correspondence with the lower LCD 14. As can be understood from FIG. 5, the GPU corresponding to the lower LCD 14 is also connected to the CPU 44a so as to be able to transmit and receive signals, and the GPU corresponding to the lower LCD 14 and the VRAM are connected with each other so as to be able to transmit and receive signals. Then, the CPU 44a, the GPU corresponding to the lower LCD 14 and the VRAM each is connected to the LCD controller corresponding to the lower LCD 14 so as to be able to transmit and receive signal, so that the lower LCD 14 is connected to this LCD controller.

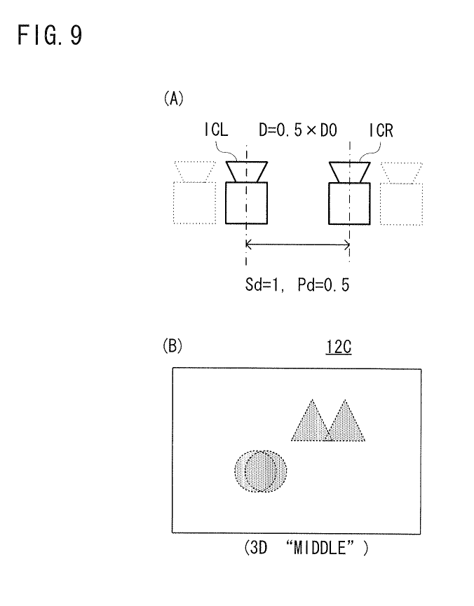

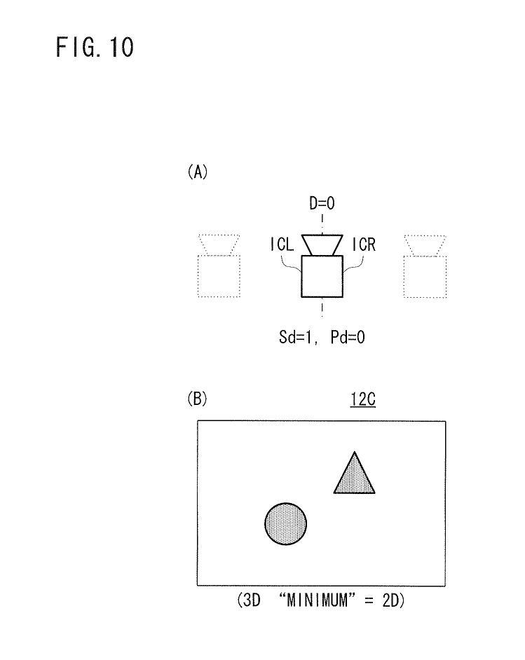

By the way, as described above, the stereoscopic image in FIG. 8(C) is an image when the distance-between cameras D becomes the maximum (D=D0: see FIG. 7), and it changes from FIG. 9(B) to FIG. 10(B) as the distance-between cameras D is shorter from FIG. 9(A) to FIG. 10(A). The distance-between cameras D is calculated according to the following equation (1).

D=Sd×Pd×D0 (1)

Here, Sd is a variable showing a value of the slider Sd of the 3D adjusting switch 20 shown in FIG. 3, and changes within a range from 0 to 1 in accordance with an operation of the slider Sd (0≦Sd≦1). Pd is a variable to be controlled by the application program such as a game program, and similarly changes within a range from 0 to 1 (0≦Pd≦1). D0 is a constant corresponding to a space between the two pupils of the human, and is set to 65 mm, for example (D0=65 mm).

In each of FIG. 7, FIG. 9(A) and FIG. 10(A), the variable Sd is 1, and the slider Sd is fixed at the upper end (Sd=1). The variable Pd changes as in 1→0.5→0 by the application program, so that the distance-between cameras D changes as in D0→(0.5×D0)→0. Then, in correspondence with the change in a direction in which the distance-between cameras D is decreased, the stereoscopic image changes as in FIG. 8(C)→FIG. 9(B)→FIG. 10(B). That is, the parallax between the left image 44L and the right image 44R decreases, and becomes equal to the planar image.

Here, if the variable Sd is fixed at 0.5 (Sd=0.5), the distance-between cameras D changes within the range from 0 to (0.5×D0). Furthermore, if the variable Sd is fixed at 0 (Sd=0), the distance-between cameras D remains 0.

In a case of a state in FIG. 10(A), that is, in a case of the minimum of the 3D display or in a case of the 2D display, the distance-between cameras D becomes 0, so that the left image 44L and the right image 44R which are written to the VRAM 44c become the same (that is, the parallax is 0). In this case as well, the LCD controller 12a alternately reads the left image 44L and the right image 44R stored in the VRAM 44c on a row-by-row basis, and draws them in the upper LCD 12c in order. Thus, a planar image (that is, image without parallax) as shown in FIG. 10(B) is displayed on the upper LCD 12c. When the barrier liquid crystal 12b for restricting the backlight to the stereoscopic image is turned off, the right and left eyes can view the planar image shown in FIG. 10(B).

Here, even if the barrier liquid crystal 12b is not turned off at this time, the planar image shown in FIG. 10(B) can still be viewed. It should be noted that when the barrier liquid crystal 12b is turned off, a suitable viewing position is extended to make the planar image appear bright. Furthermore, the LCD controller 12a may read only one of the left image 44L and the right image 44R in place of alternately reading them to draw it in the upper LCD 12c. In this case as well, the planar image as shown in FIG. 10(B) is displayed on the upper LCD 12c.

For example, when the power button 24k is turned on to turn the power source of the game apparatus 10 on, the game apparatus 10 is booted up to display a main menu screen not shown on the lower LCD 14 (or, the upper LCD 12c). The player selects a desired application on the main menu screen to thereby make an instruction for the execution. When execution of the application is instructed, processing is executed according to the application program corresponding to the application in the game apparatus 10.

Although illustration is omitted, the game apparatus 10 of this embodiment is an upward compatible model to the game apparatus (product name: Nintendo DS, Nintendo DS Light, Nintendo DSi) being the subordinate model that are manufactured and sold by the applicants of this application, and can execute applications for the downward compatible game apparatus.

Although the illustration is omitted, the CPU 44a includes a plurality of cores (CPU cores), and the CPU core (referred to as a “first CPU core”, for convenience of description) for executing the applications for the game apparatus 10 and the CPU core for executing the applications for the game apparatus of the subordinate model (referred to as a “second CPU core” for convenience of description) are different. Accordingly, in a case that the application for the game apparatus of the subordinate model is executed, since the task is executed by the second CPU core, a mode (first mode) capable of executing the application for the game apparatus 10 is switched to a second mode different from the first mode.

More specifically, in a case that the first mode is switched to the second mode, the game apparatus 10 is rebooted and booted up in the second mode for executing the application for the game apparatus of the subordinate model in which the task is executed by the second CPU core. Furthermore, when the power button 24k is turned on in the second mode, a switch to the first mode is made without the power source of the game apparatus 10 being turned off. That is, the game apparatus 10 is rebooted and booted up in the first mode. Accordingly, the task is executed by the first CPU core.

Whether the application to be executed in the first mode or the application to be executed in the second mode can be identified on the basis of identification information included in header information of the application program. Although a description in detail is omitted, the application program of the application to be executed in the first mode and the application program of the application to be executed in the second mode are stored in different areas of the NAND-type flash memory 48, and therefore, this can be identified from the area in which the application program is stored. In addition, in a case that an application program is loaded from a game card, this can be identified from the identification information, such as a volume label of the game card. As to these methods, more accurate identification is possible by combining two or more methods.

Additionally, if the game apparatus 10 is closed and in an unused state in a state that the power source of the game apparatus 10 is turned on, the game apparatus 10 functions as a pedometer, and starts to count step counts. As described above, the processing that is being executed (processing of the application) is suspended at this time, and the sleep is executed. Here, depending on the kind of the application and the situation of the execution (proceeding) of the application, the sleep may not be executed.

An explanation in a case that the game apparatus 10 functions as a pedometer is described below, but the first mode and the second mode are approximately the same in basic processing, and thus, if different processing is executed, an explanation is separately made between the first mode and the second mode.

As to the game apparatus 10, the microcomputer 56 counts step counts on the basis of outputs from the acceleration sensor 54. The pedometer using the acceleration sensor 54 has already been known, and therefore, although the detailed description thereof is omitted, the step counts are counted (detected) in accordance with the magnitude of the accelerations.

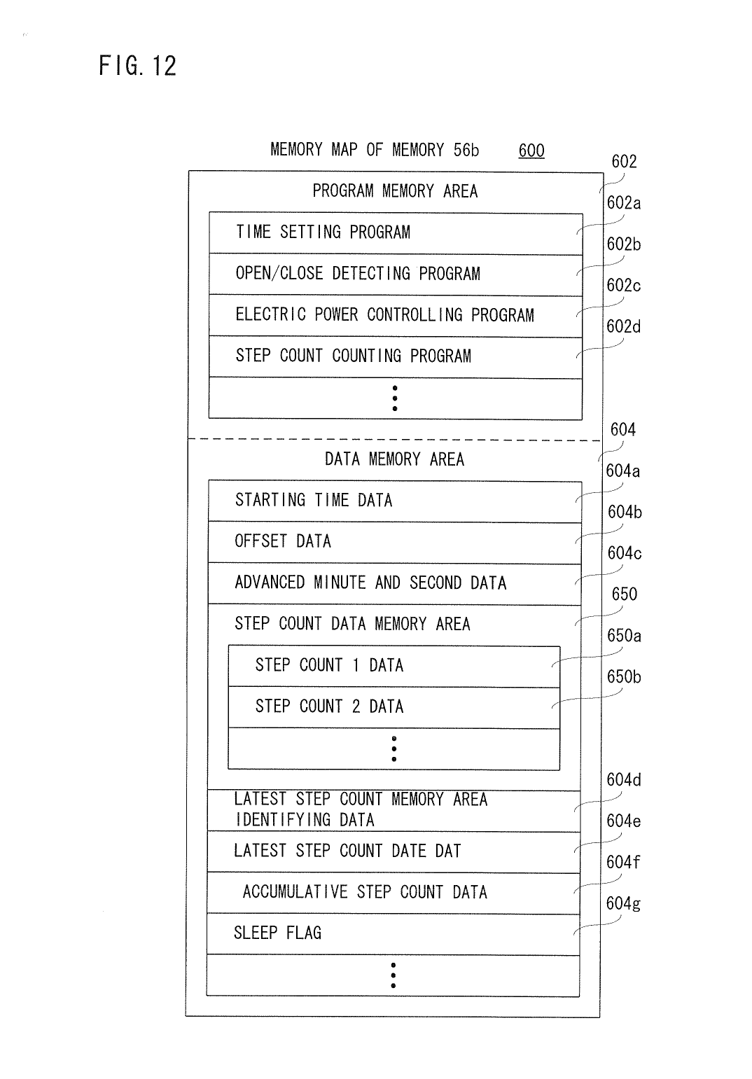

Furthermore, the step counts are managed as a cluster every first predetermined time (one hour in this embodiment), and stored in the memory 56b of the microcomputer 56. As described later, in the memory 56b, a step count data memory area 650 (see FIG. 12) is provided, and in this embodiment, the step count data memory area 650 can store step count data (650a, 650b, . . . ) for a short time (24 hours×7 days). In addition, in the first mode, the step count data (650a, 650b, . . . ) stored in the memory 56b of the microcomputer 56 is saved (moved to) in the NAND-type flash memory 48 of the game apparatus 10 every second predetermined time (24 hours in this embodiment). Accordingly, in the second mode, the step count data (650a, 650b, . . . ) stored in the memory 56b of the microcomputer 56 is saved in the NAND-type flash memory 48 when the second predetermined time has elapsed after a switch to the first mode. In this embodiment, the NAND-type flash memory 48 has a step count data memory area 48a capable of storing the step count data (650a, 650b, . . . ) for a long time (10 years). That is, the step count data memory area 48a has a capacity larger than the step count data memory area 650.

It should be noted that in this embodiment, in a case that a switch from the first mode to the second mode is made, or in a case that the power source of the game apparatus 10 is turned off as well, the step count data stored in the memory 56b is saved in the NAND-type flash memory 48 before the switch or turning the power source off.

Here, as described above, in a case that the power button 24k is turned on in the second mode, a switch to the first mode is made, and thus, when the power button 24k is turned on after the switch to the first mode, the power source of the game apparatus 10 is turned off.

For example, in a case that the sleep mode is set in a state that the game apparatus 10 is in a closed state in the first mode, when the second predetermined time has elapsed, the CPU 44a is booted up by a control signal from the microcomputer 56. That is, the clock of the CPU 44a is operated by the microcomputer 56. Furthermore, the microcomputer 56 controls the power source management IC 52 to start supply electric power to the NAND-type flash memory 48. Thereafter, in response to a saving request from the microcomputer 56, the CPU 44a reads the step count data (650a, 650b, . . . ) from the memory 56b of the microcomputer 56, and stores the same in the NAND-type flash memory 48. Here, when the power source of the game apparatus 10 is turned on, counting the second predetermined time is started, and the data about the current time (starting time) at this time is stored in the NAND-type flash memory 48. Accordingly, the data about the starting time is updated every time that the power source of the game apparatus 10 is turned on. Here, the starting time may be a current time when the sleep is executed.

On the other hand, in a case that the sleep mode is not set in a state that the game apparatus 10 is in the closed in the first mode as described above, the CPU 44a reads the step count data (650a, 650b, . . . ) from the memory 56b of the microcomputer 56, and saves the same in the NAND-type flash memory 48 when a lapse of the second predetermined time. In this case, the CPU 44a determines whether or not the second predetermined time has elapsed on the basis of the time counted by the timer 440 provided to the game apparatus itself. The timer 440 is a timer (Tick) updated by the clock for operating the CPU 44a. The timer 440 counts a current time (including year, month, and day) in a case that the power source of the game apparatus 10 is turned on and is in the used state. Here, in a case that the sleep state prevails or in a case that the power source of the game apparatus 10 is turned off, the clock of the CPU 44a is stopped, so that the timer 440 is also stopped. Accordingly, the CPU 44a reads the current time from the RTC 56a, and corrects the count value (current time) of the timer 440 when the power source of the game apparatus 10 is turned on, or when the sleep state is canceled. Although an explanation in detail is omitted, when the count value of the timer 440 is corrected, a different time (offset) between the current time set by the user or the player and the current time counted by the RTC 56a when this current time is set is taken into consideration. Data (offset data) about the offset is stored in the memory 442 within the CPU 44a, and updated when the current time is changed (reset) by the user.

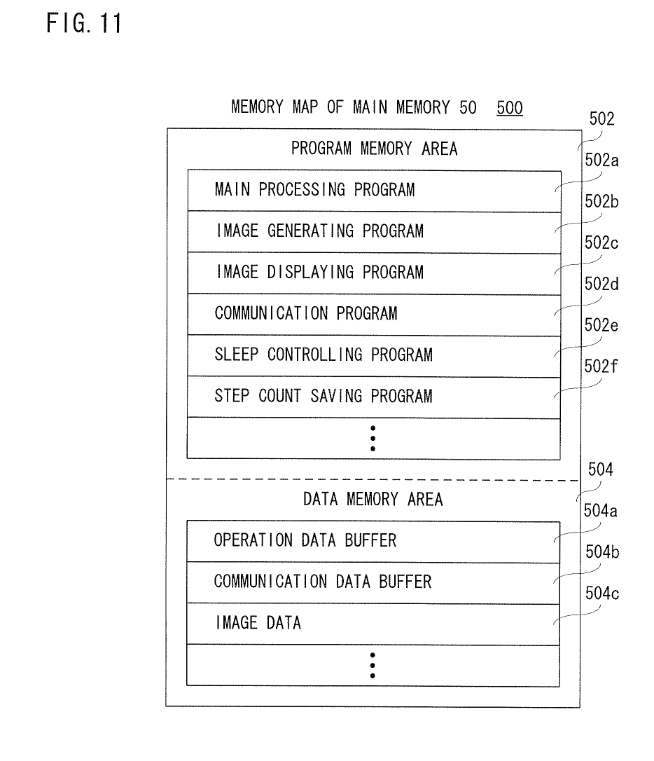

FIG. 11 is an illustrative view showing one example of a memory map 500 of a main memory 50 shown in FIG. 4. As shown in FIG. 11, the main memory 50 includes a program memory area 502 and a data memory area 504. In the program memory area 502, a main processing program 502a, an image generating program 502b, an image displaying program 502c, a communication program 502d, a sleep controlling program 502e, a step count saving program 502f, etc. are stored.

The main processing program 502a is a program for processing a main routine of the game apparatus 10 itself. The image generating program 502b is a program for generating display image data to display various screens, such as a main menu screen, etc. by using image data 504c described later. The image displaying program 502c is a program for outputting display image data generated according to the image generating program 502b on the stereoscopic LCD 12 or the lower LCD 14, or both of them.

The communication program 502d is a program for making a communication with other game apparatuses 10 and computers or access points. The sleep controlling program 502e is a program for instructing the microcomputer 56 to execute the sleep, and restarting the suspended processing in response to an instruction of cancellation of the sleep from the microcomputer 56. The step count saving program 502f is a program for saving the step count data (650a, 650b, . . . ) stored in the memory 56b within the microcomputer 56 in the NAND-type flash memory 48 at a predetermined timing. In this embodiment, the predetermined timing is a time when the second predetermined time (24 hours, for example) has elapsed, before the first mode is switched to the second mode, and before the power source of the game apparatus 10 is turned off.

Although illustration is omitted, an application program and a sound outputting program are also stored in the program memory area 502. The application program is a program as to an arbitrary application such as a virtual game, etc. The application program is loaded from the SD card inserted into the SD card slot 34 and from the game card inserted into the game card slot 38, or loaded from the NAND-type flash memory 48 or downloaded. The sound outputting program is a program for outputting sound, such as music (BGM), a sound effect, etc. by using sound (music) data not shown.

A data memory area 504 is provided with an operation data buffer 504a and a communication data buffer 504b. Furthermore, in the data memory area 504, image data 504c is stored.

The operation data buffer 504a stores (temporarily stores) in chronological order operation data input from the operation buttons (24a-24g) and the analog pad 26 and touch position data input from the touch panel 16. The operation data and the touch position data are deleted from the operation data buffer 504a when being used in the information processing such as the game processing, etc. The communication data buffer 504b stores (temporarily stores) data to be transmitted (game data, content data, etc.) and received data when a communication with other game apparatuses 10, etc. (except for the in-passing communication) is made in the normal mode. The image data 504c is data of polygon data and texture data, etc. for generating the display image data.

Although illustration is omitted, in the data memory area 504, other data such as note data is stored, or counters (timers) and flags required for the information processing including the processing of the application are also provided.

FIG. 12 is an illustrative view showing a memory map 600 of the memory 56b contained in the microcomputer 56. As shown in FIG. 12, the memory 56b includes a program memory area 602 and a data memory area 604. In the program memory area 602, a time setting program 602a, an open/close detecting program 602b, electric power controlling program 602c, a step count counting program 602d, etc. are stored.

The time setting program 602a is a program for storing (setting) starting time data 604a, offset data 604b and advanced minute and second data 604c as described later. The open/close detecting program 602b is a program for detecting whether the game apparatus 10 is in the opened state or the closed state depending on the state of the opening and closing switch 60 (ON or OFF), and notifies the CPU 44a of the opened state (cover opening information) or the closed state (cover closing information). In this embodiment, in a case that an ON signal is applied from the opening and closing switch 60 to the microcomputer 56, the game apparatus 10 is in the opened state, and the cover opening information is notified to the CPU 44a. Alternatively, in a case that an OFF signal is applied from the opening and closing switch 60 to the microcomputer 56, the game apparatus 10 is in the closed state, and the cover closing information is notified to the CPU 44a.

The electric power controlling program 602c is a program for instructing the power source management IC 52 to control the supply and stop of electric power to each of the components of the game apparatus 10. The step count counting program 602d is a program for counting step counts on the basis of an acceleration signal input from the acceleration sensor 54 in the unused state of the game apparatus 10. More specifically, the step count counting program 602d adds one to step counts corresponding to the step count data (650a, 650b, . . . ) stored in the current memory area indicated by the latest step count memory area identifying data 604d and adds one to step counts corresponding to the accumulative step count data 604e when an acceleration signal that is input from the acceleration sensor 54 is equal to or more than a predetermined value.

Although illustration is omitted, in the program memory area 602, other programs necessary for the information processing are also stored.

In the data memory area 604, starting time data 604a, offset data 604b, advanced minute and second data 604c, latest step count memory area identifying data 604d, latest step count date data 604e and accumulative step count data 604f are stored. Furthermore, the data memory area 604 is provided with a step count data memory area 650. In addition, the data memory area 604 is provided with a sleep flag 604g.

The starting time data 604a is data about a time (starting time) when counting the second predetermined time is started. Here, the starting time includes information of year, month and day. The offset data 604b is data about the offset between the current time (current time by the user setting) that the user or the player sets (resets) to the game apparatus 10 and the RTC 56a. Accordingly, the current time by the user setting is updated by the current time counted by the RTC 56a and the offset corresponding to the offset data 604b. As described above, the offset data is calculated when the user sets the (resets) the current time, and stored in the memory 442 within the CPU 44a. Accordingly, the offset data 604b is acquired from the CPU 44a by the microcomputer 56.

The advanced minute and second data 604c is data about minutes and seconds indicated by the current time counted by the RTC 56a corresponding to 59 minutes and 59 seconds per hour indicated by the current time by the user setting. This is because the step count data (650a, 650b, . . . ) corresponding to the counted step counts is stored as a cluster every first predetermined time (one hour) in the memory 56b of the microcomputer 56 as described above, and the section every hour is set to 59 minutes 59 seconds per hour indicated by the current time by the user setting. The advanced minute and second data is also calculated when the user sets the current time and stored in the memory 442 within the CPU 44a. Accordingly, the advanced minute and second data 604c is obtained from the CPU 44a by the microcomputer 56. Here, in a case that the current time of the user setting is reset, the advanced minute and second data stored in the memory 442 is updated.

The step count data memory area 650 includes a plurality of memory areas, and in each memory area, step count data every first predetermined time (one hour in this embodiment) is stored. In the example shown in FIG. 12, step count 1 data 650a, step count 2 data 650b, . . . are stored.

Here, although a description in detail is omitted, memory areas for one week (24 hours×7 days) are provided in the step count data memory area 650 as described above. The latest step count memory area identifying data 604d is data about identification information for identifying a memory area in which the latest step count data (650a, 650b, . . . ) is stored. As described above, the step count data (650a, 650b, . . . ) is stored as a cluster every first predetermined time, and therefore, the recording area of the step count data (650a, 650b, . . . ) is changed in a predetermined order, for example.

The latest step count date data 604e is data about a date and time (latest step count date and time) to be added to the latest step count data (650a, 650b, . . . ). Here, the latest step count date and time includes information about years and months. The latest step count date data 604e is updated when the memory area of the step count data (650a, 650b, . . . ) is changed. If the date and time about the latest step count data (650a, 650b, . . . ) is found, the date and time about the past step count data (650a, 650b, . . . ) stored before then can be known by going back the memory area changed according to the predetermined order by one hour. The accumulative step count data 604f is data about a total number of step counts (cumulative value) counted from when the game apparatus 10 is first used as a pedometer.

The sleep flag 604g is a flag for determining whether or not the sleep is being executed, and is made up of a one bit register. When the sleep flag 604g is turned on (established), a data value “1” is set to the register. When the sleep flag 604e is turned off (unestablished), a data value “0” is set to the register. Here, the sleep flag 604g is turned on when execution of the sleep is instructed by the CPU 44a, and is turned off when the sleep is canceled.

Although illustration is omitted, in the data memory area 604, other data is stored, or counters (timers) and other flags, etc. necessary for the information processing are also provided.

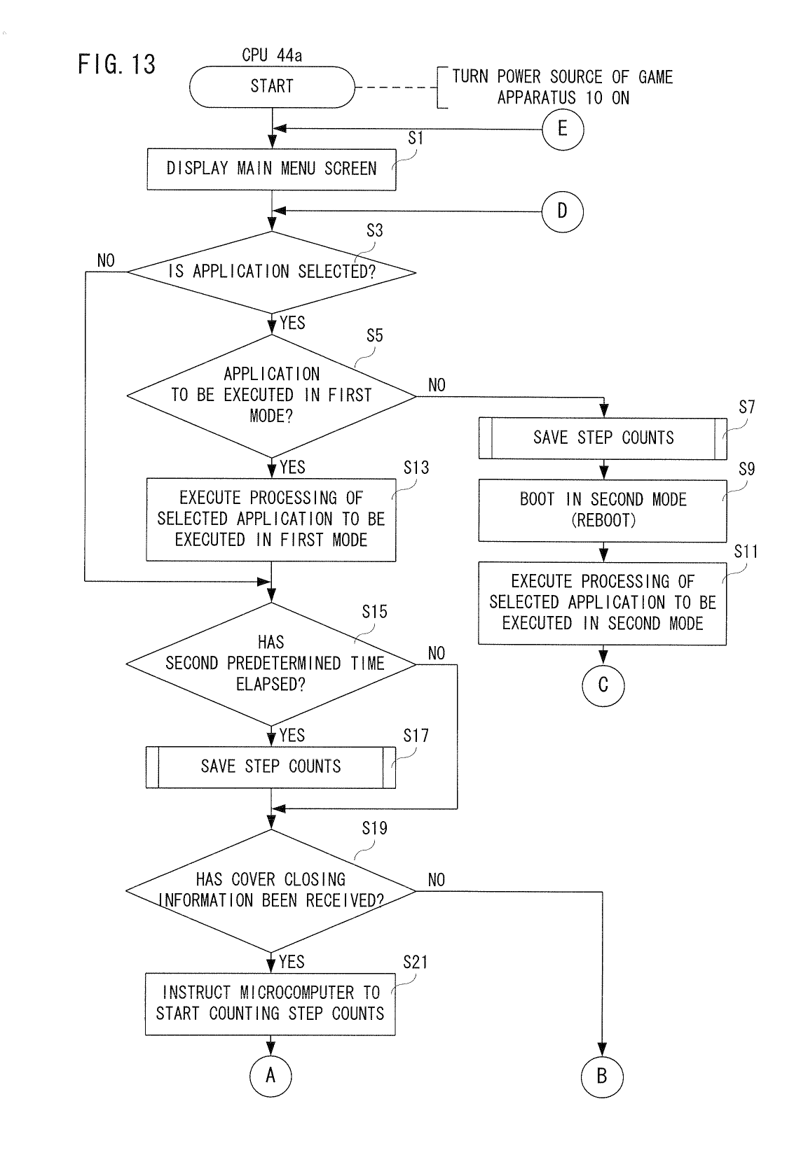

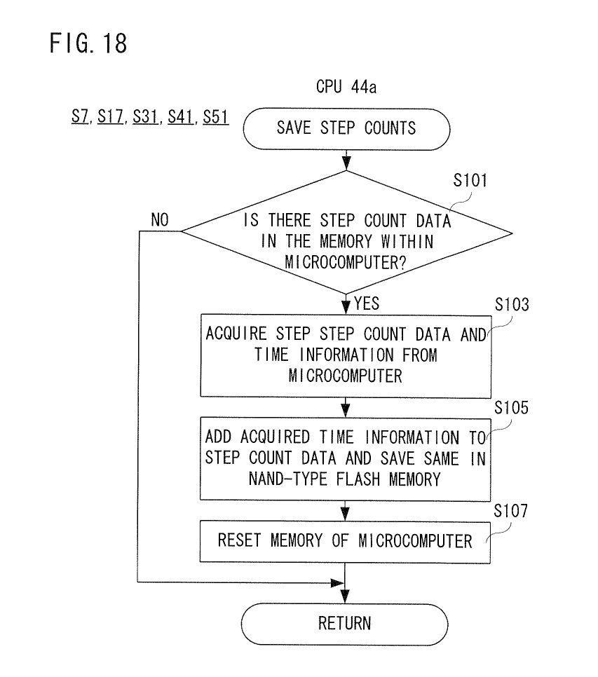

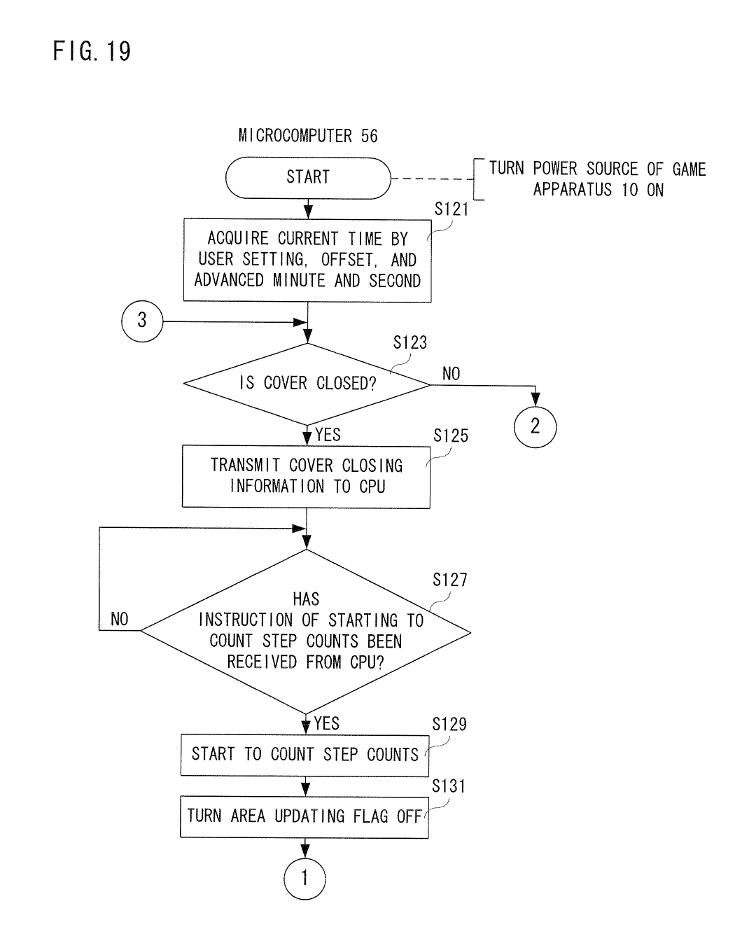

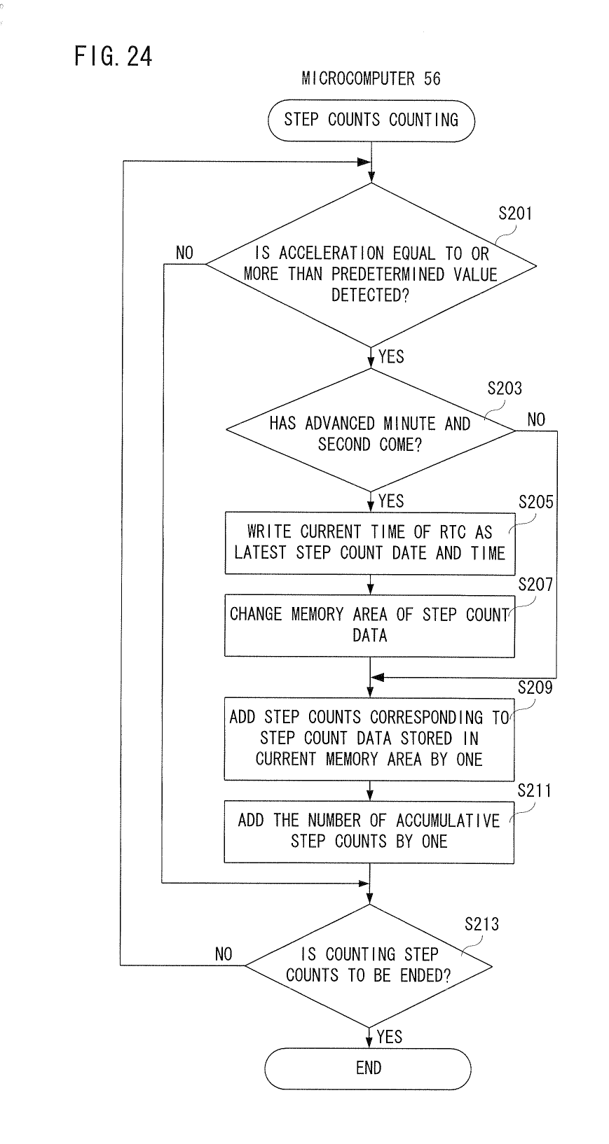

More specifically, the CPU 44a and the microcomputer 56 shown in FIG. 4 execute information processing to thereby count and save step counts. More specifically, the CPU 44a executes entire processing shown in FIG. 13-FIG. 17 and step count saving processing shown in FIG. 18. Furthermore, the microcomputer 56 executes entire processing shown in FIG. 19-FIG. 23 and step count counting processing shown in FIG. 24. The respective processing is described below. Here, as to the same processing, a description about redundant contents is omitted.

As shown in FIG. 13, when the power source of the game apparatus 10 is turned on, the CPU 44a starts entire processing to display a main menu screen on the stereoscopic LCD 12 in a step S1. Here, at the beginning of turning on the power source of the game apparatus 10, the game apparatus 10 is booted up in the first mode. Furthermore, although an illustration is omitted, an image (icon) representing an application (application executable in the first mode or the second mode) being executable by the game apparatus 10 is displayed on the main menu screen. In a next step S3, it is determined whether or not an application is selected. If “NO” in the step S3, that is, if an application is not selected, the process directly proceeds to a step S15. If “YES” in the step S3, that is, if an application is selected, it is determined whether or not the selected application is an application to be executed in the first mode in a step S5. The determination method as to whether the application is to be executed in the first mode or the second mode is as described above.

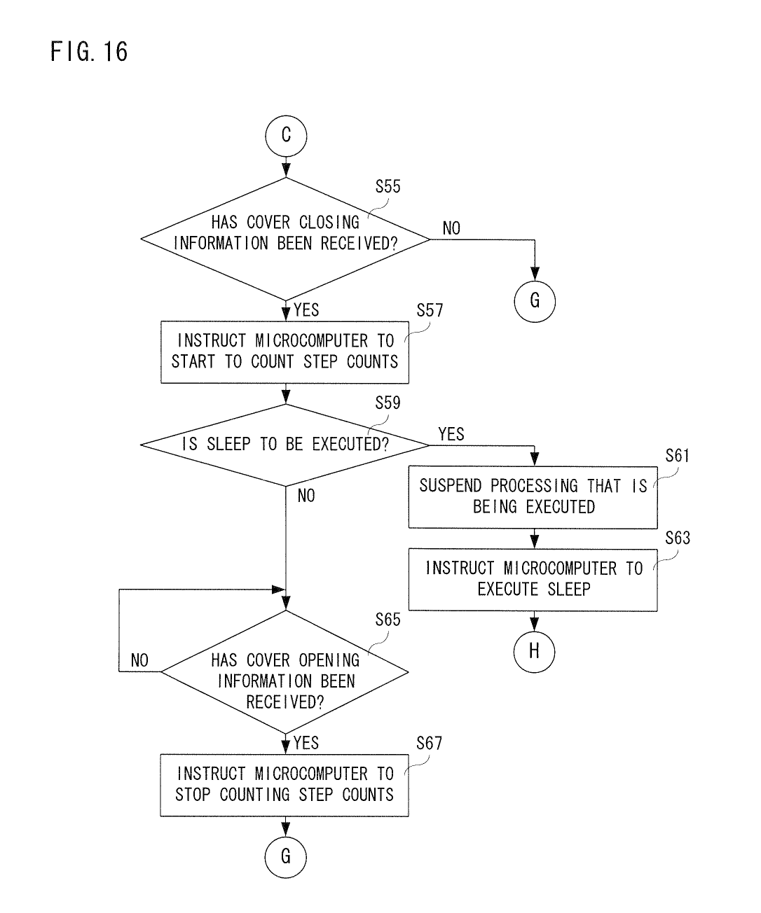

If “NO” in the step S5, that is, if the selected application is an application to be executed in the second mode, the step count saving processing (see FIG. 18) described later is executed in a step S7, and the game apparatus 10 is booted up in the second mode in a step S9. That is, the game apparatus 10 is rebooted in order to execute the application in the second mode by the second CPU core. Then, in a step S11, the processing of the selected application to be executed in the second mode is executed, and the process proceeds to a step S55 shown in FIG. 16. Although illustration is omitted, the processing of the application is executed in a task different from the entire processing.

On the other hand, if “YES” in the step S5, that is, if the selected application is an application to be executed in the first mode, the processing of the selected application to be executed in the first mode is executed in a step S13, and it is determined whether or not the second predetermined time (24 hours, for example) has elapsed in the step S15.

Although an illustration is omitted, when the power source of the game apparatus 10 is turned on, counting the second predetermined time is started. For example, the power source of the game apparatus 10 is turned on, the count value of the timer 440 is corrected on the basis of the current time counted by the RTC 56a and the offset indicated by the set time data stored in the memory 442, and the count value at this time is stored in the NAND-type flash memory 48 as a starting time. Here, as described above, when the sleep is executed, counting the second predetermined time may be started. In such a case, when the sleep is executed, the count value of the timer 440 is stored in the NAND-type flash memory 48 as a starting time. Accordingly, the CPU 44a determines whether or not the second predetermined time has elapsed from the starting time stored in the NAND-type flash memory 48 with reference to the count value of the timer 440 in the step S15. This holds true for the step S29 described later.

If “NO” in the step S15, that is, if the second predetermined time has not elapsed, the process directly proceeds to a step S19. On the other hand, if “YES” in the step S15, that is, if a second predetermined time has elapsed, the step count saving processing is executed in a step S17, and the process proceeds to the step S19.

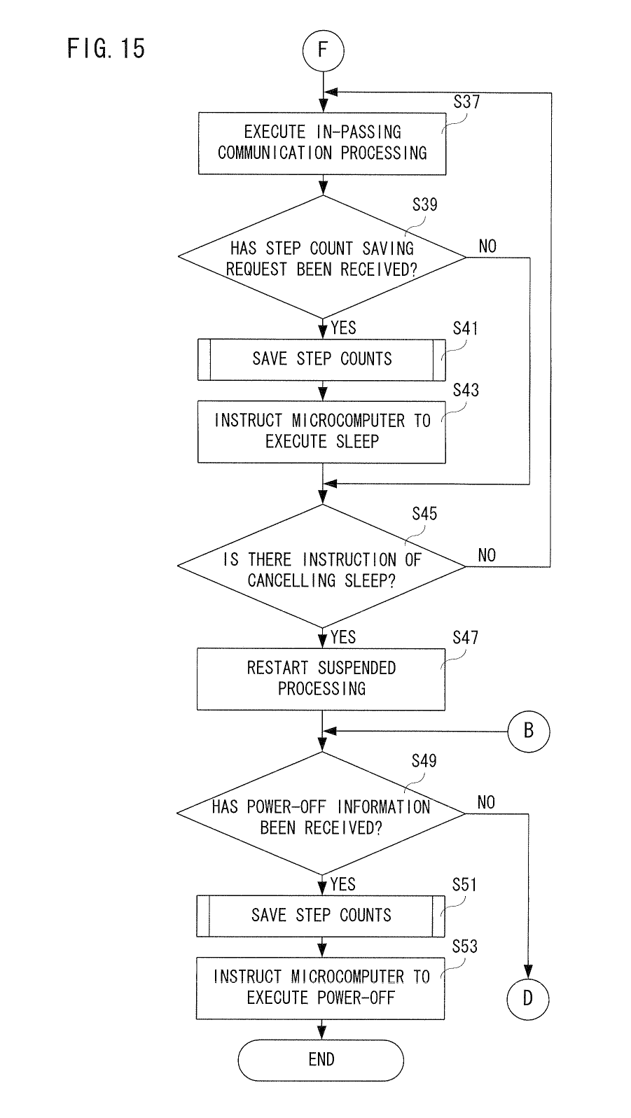

In the step S19, it is determined whether or not the cover closing information from the microcomputer 56 has been received. If “NO” in the step S19, that is, if the cover closing information from the microcomputer 56 has not been received, the process proceeds to a step S49 shown in FIG. 15. On the other hand, if “YES” in the step S19, that is, if the cover closing information from the microcomputer 56 has been received, starting to count step counts is instructed to the microcomputer 56 in a step S21.

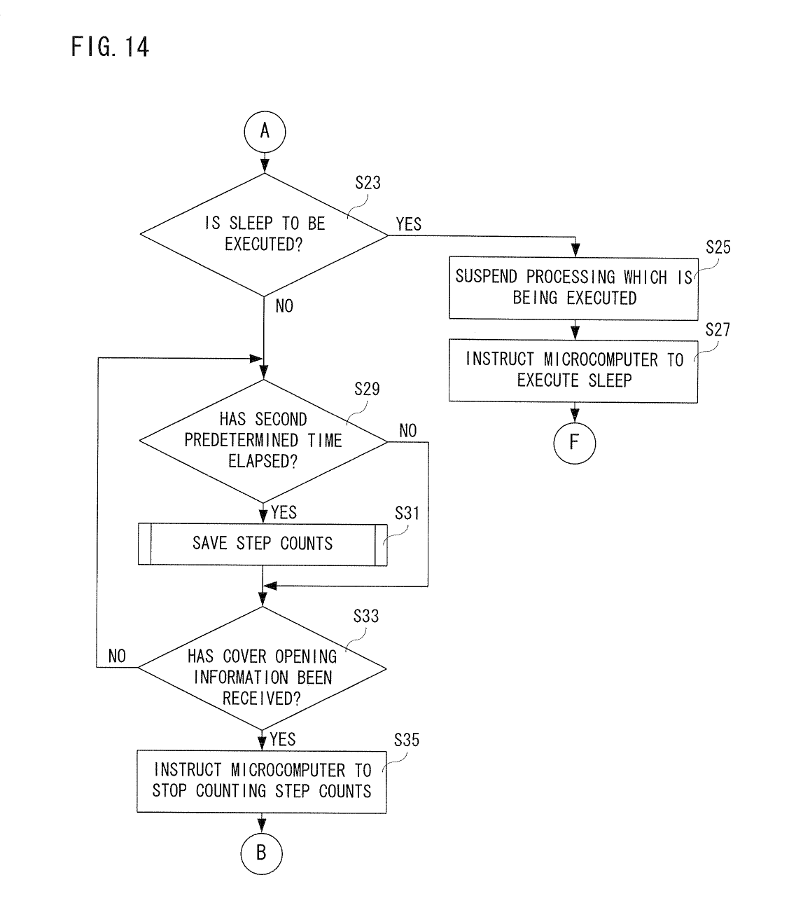

Succeedingly, in a step S23 shown in FIG. 14, it is determined whether or not the sleep is to be executed. Depending on the applications that are being executed, some are slept and others are not slept. Moreover, depending on the progressing of the application, some cannot sleep. Thus, the CPU 44a determines whether or not the processing that is being executed is suspended, and the sleep is executable. If “YES” in the step S23, that is, if the sleep is executed, the processing that is being executed (processing of the application to be executed in the first mode) is suspended in a step S25, execution of the sleep is instructed to the microcomputer 56 in a step S27, and the process proceeds to a step S37 shown in FIG. 15. That is, in the step S27, the task executing the processing of the application is suspended, and a shift to the sleep mode is made.

On the other hand, if “NO” in the step S23, that is, if the sleep is not executed, it is determined whether or not the second predetermined time has elapsed in a step S29. If “NO” in the step S29, the process directly proceeds to a step S33 as it is. On the other hand, if “YES” in the step S29, the step count saving processing is executed in a step S31, and the process proceeds to the step S33.

In the step S33, it is determined whether or not the cover opening information from the microcomputer 56 has been received. If “NO” in the step S33, that is, if the cover opening information from the microcomputer 56 has not been received, the process returns to the step S29 as it is. On the other hand, if “YES” in the step S33, that is, if the cover opening information from the microcomputer 56 has been received, stopping counting the step count is instructed to the microcomputer 56 in a step S35, and the process proceeds to the step S49 shown in FIG. 15.

As shown in FIG. 15, in the step S37, in-passing communication processing as described above is executed. Here, although it is shown that the in-passing communication processing is executed by the CPU 44a for the sake of simplicity, but in reality, as described above, the wireless module 46 transmits and receives a connection request/response signal (beacon) for searching for other appliances, and when another appliance that meets the condition is found through the search, the CPU 44a is booted up in response to a control signal from the wireless communication module 46. Then, the wireless module 46 applies an instruction of starting a communication to the CPU 44a to thereby execute the in-passing communication processing.

Succeedingly, in a step S39, it is determined whether or not a step count saving request has been received from the microcomputer 56. Here, before the microcomputer 56 issues a step count saving request, the CPU 44a is booted up and the electric power is supplied to the NAND-type flash memory 48 by the microcomputer 56. If “NO” in the step S39, that is, if a step count saving request from the microcomputer 56 has not been received, the process proceeds to a step S45 as it is. On the other hand, if “YES” in the step S39, that is, if a step count saving request has been received, the step count saving processing is executed in a step S41, an execution of the sleep is instructed to the microcomputer 56 in a step S43, and a return to the sleep state is made. Thereafter, the process proceeds to the step S45.

In the step S45, it is determined whether or not there is an instruction of cancelling the sleep from the microcomputer 56. If “NO” in the step S45, that is, if there is no instruction of cancelling the sleep from the microcomputer 56, the process returns to the step S37 as it is, and the sleep mode is continued. On the other hand, if “YES” in the step S45, that is, if there is an instruction of cancelling the sleep form the microcomputer 56, the suspended processing is restarted in a step S47, and it is determined whether or not power-off information from the microcomputer 56 has been received in a step S49. That is, in the step S47, the temporarily stopped task is restarted, and a transition to the normal mode is made.

If “NO” in the step S49, that is, if power-off information from the microcomputer 56 has not been received, the process returns to the step S3 shown in FIG. 13. On the other hand, if “YES” in the step S49, that is, if power-off information from the microcomputer 56 has been received, the step count saving processing is executed in a step S51, and an execution of turning the power source off is instructed to the microcomputer 56 in a step S53, and the entire processing is ended. Thereafter, as described later, the power source of the game apparatus 10 is turned off by the microcomputer 56.

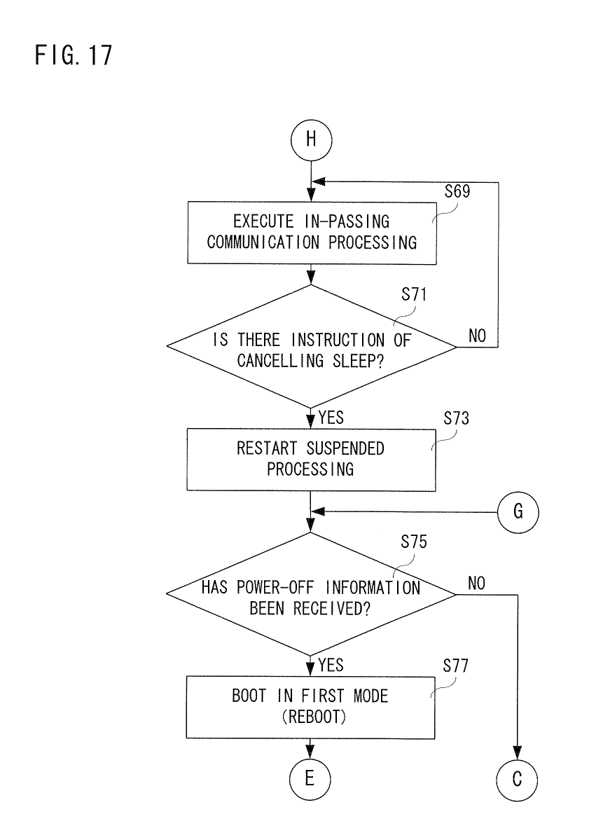

Furthermore, as described above, when in the step S11, the processing of the selected application to be executed in the second mode is executed, it is determined whether or not the cover closing information has been received in the step S55 as shown in FIG. 16. If “NO” in the step S55, the process proceeds to a step S75 shown in FIG. 17 as it is. On the other hand, if “YES” in the step S55, starting to count step counts is instructed to the microcomputer 56 in a step S57, and it is determined whether or not sleep is to be executed in a step S59.

If “YES” in the step S59, the processing that is being executed (processing of the application to be executed in the second mode) is suspended in a step S61, an execution of the sleep is instructed to the microcomputer 56 in a step S63, and the process proceeds to a step S69 shown in FIG. 17. On the other hand, if “NO” in the step S59, it is determined whether or not the cover opening information has been received in a step S65. If “NO” in the step S65, the process returns to the same step S65. On the other hand, if “YES” in the step S65, stopping counting the step counts is instructed to the microcomputer 56 in a step S67, and the process proceeds to the step S75.

As shown in FIG. 17, in the step S69, in-passing communication processing is executed. In a succeeding step S71, it is determined whether or not there is an instruction of cancelling the sleep, for example, it is determined whether or not the cover opening information has been received. If “NO” in the step S71, the process returns to the step S69 as it is. On the other hand, if “YES” in the step S71, the suspended processing is restarted in a step S73, and it is determined whether or not the power-off information has been received in the step S75.

If “NO” in the step S75, the process returns to the step S55 shown in FIG. 16 as it is. On the other hand, if “YES” in the step S75, the game apparatus 10 is booted up in the first mode in a step S77. That is, the CPU 44a reboots the game apparatus 10 in order to execute the task by the first CPU core. Then, the process returns to the step S1 shown in FIG. 13.

Accordingly, the step count data as to the step counts counted in the second mode is saved in the NAND-type flash memory 48 at a time when the second predetermined time has elapsed after a switch to the first mode is made.

FIG. 18 is a flowchart showing step count saving processing in the steps S7, S17, S31, S41 and S51 shown in FIG. 13-FIG. 15. As shown in FIG. 18, when the CPU 44a starts the step count saving processing, it is determined whether or not the step count data (650a, 650b, . . . ) is stored in the memory 56b within the microcomputer 56 in a step S101.

If “NO” in the step S101, that is, if the step count data (650a, 650b, . . . ) is not stored in the memory 56b within the microcomputer 56, the process returns to the entire processing shown in FIG. 13-FIG. 17 as it is. On the other hand, if “YES” in the step 5101, that is, if the step count data (650a, 650b, . . . ) is stored in the memory 56b within the microcomputer 56, the step count data (650a, 650b, . . . ) and the time information are acquired from the microcomputer 56 in a step S103. As described above, the CPU 44a acquires the time information of the latest step count data (650a, 650b, . . . ) from the latest step count date data 604e. Then, as described above, the time information as to the past step count data (650a, 650b, . . . ) that has been stored before the latest step count data (650a, 650b, . . . ) is acquired by going back from the date and time indicated by the latest step count date data 604e by one hour. Here, the time information is acquired by being corrected by the offset corresponding to the offset data is stored in the memory 442 about which the current time indicated by the latest step count date data 604e.

In a next step S105, the time information acquired from the microcomputer 56 is added to each step count data (650a, 650b, . . . ) and saved in the NAND-type flash memory 48. Then, in a step 5107, the memory 56b of the microcomputer 56 is reset, and the process returns to the entire processing.

Here, in the step S107, the CPU 44a instructs the microcomputer 56 to reset the memory 56b, and in response thereto, the microcomputer 56 erases all the step count data (650a, 650b, . . . ) stored in the memory 56b.

As described above, FIG. 19-FIG. 23 is a flowchart showing entire processing by the microcomputer 56. As shown in FIG. 19, when the power source of the game apparatus 10 is turned on, the microcomputer 56 starts the entire processing to acquire a current time by the user setting, an offset, and advanced minute and second data in a step S121. Here, the microcomputer 56 acquires the current time by the user setting counted by the timer 440 from the CPU 44a, and stores corresponding current time data in the memory 56 as starting time data 604a. Furthermore, the microcomputer 56a acquires the offset data from the CPU 44a, and stores the same in the memory 56b. In addition, the microcomputer 56 acquires the advanced minute and the second data from the CPU 44a, and stores the same in the memory 56b.

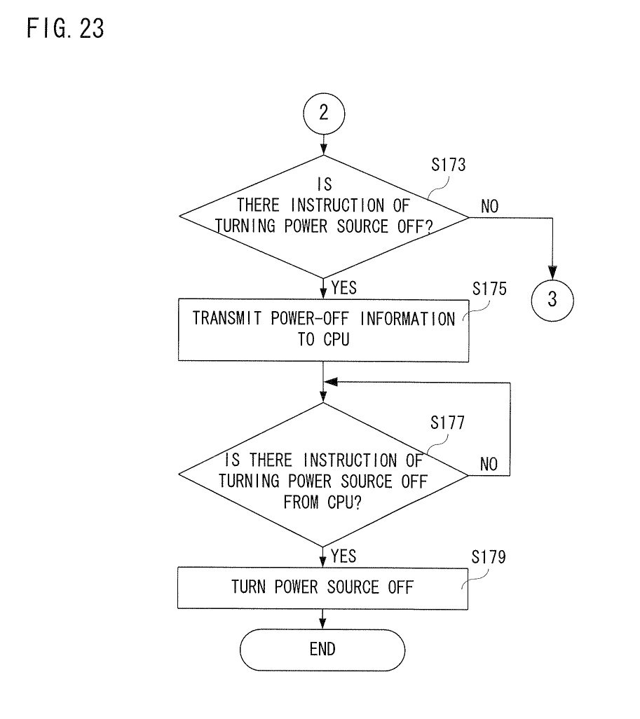

In a succeeding step S123, it is determined whether or not the cover is closed. Here, the microcomputer 56 determines whether or not an OFF signal is applied from the opening and closing switch 60. If “NO” in the step S123, that is, if the cover is not closed, the process proceeds to a step S173 shown in FIG. 23 as it is. On the other hand, if “YES” in the step S123, that is, if the cover is closed, the cover closing information is transmitted to the CPU 44a in a step S125. In a next step S127, it is determined whether or not an instruction of starting to count step counts from the CPU 44a has been received.

If “NO” in the step S127, that is, if an instruction of starting to count step counts from the CPU 44a has not been received, the process returns to the same step S127. On the other hand, if “YES” in the step S127, that is, if an instruction of starting to count step counts from the CPU 44a has been received, counting step counts is started in a step S129. That is, the microcomputer 56 executes the step count counting processing (see FIG. 24) described later by a task different form the entire processing.

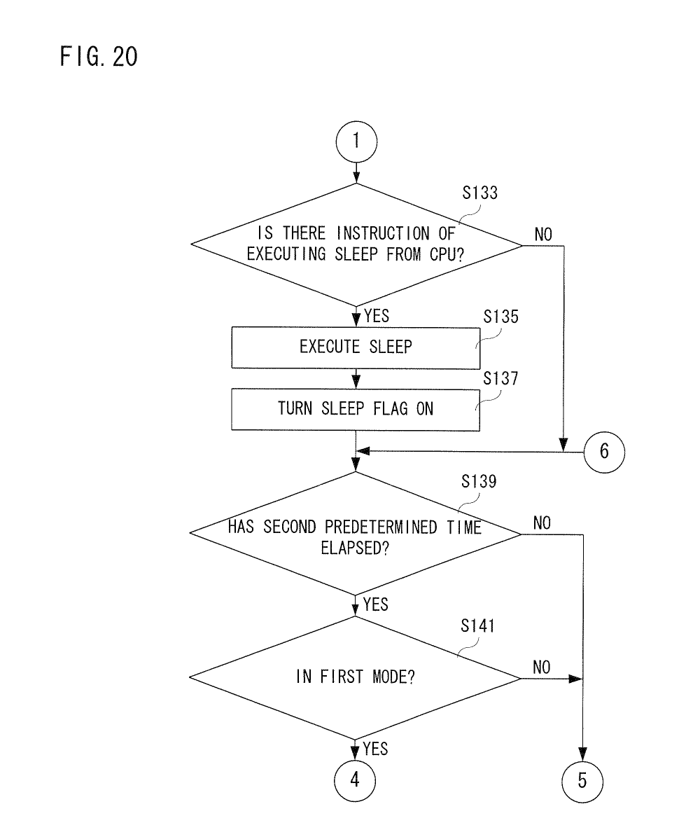

Succeedingly, in a step S131, the area updating flag 604g is turned off, and it is determined whether or not there is an instruction of executing a sleep from the CPU 44a in a step S133 shown in FIG. 20. If “NO” in the step S133, that is, if there is no instruction of executing the sleep from the CPU 44a, the process proceeds to a step S139 as it is. On the other hand, if “YES” in the step S133, that is, if there is an instruction of execution of the sleep from the CPU 44a, a sleep is executed in a step S135, the sleep flag 604g is turned on in a step S137, and the process proceeds to the step S139.

Here, as described above, when the microcomputer 56 executes the sleep, it controls the power source management IC 52 to stop supplying electric power to the components except for the wireless module 46. Here, the CPU 44a, the power source management IC 52 and the microcomputer 56 are always supplied with electric power.

In the step S139, it is determined whether or not the second predetermined time (24 hours in this embodiment) has elapsed. Here, the microcomputer 56 calculates the current time of the user setting from the current time counted by the RTC 56a and the offset indicated by the offset data 604b, and determines whether or not the second predetermined time has elapsed from the starting time indicated by the starting time data 604a. Here, when the sleep is executed, counting the second predetermined time may be started. In such a case, when the sleep is executed, the current time by the user setting is acquired from the CPU 44a, and the acquired current time by the user setting may be stored in the memory 56b as a starting time.

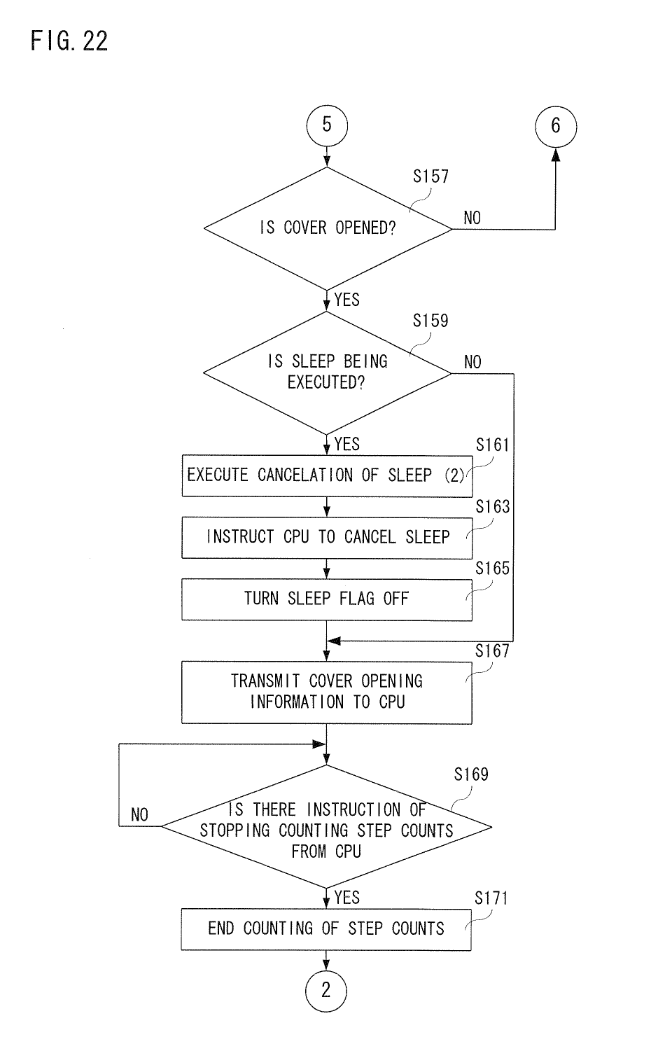

If “NO” in the step S139, that is, if the second predetermined time has not elapsed, the process proceeds to a step S157 shown in FIG. 22. On the other hand, if “YES” in the step S139, that is, if the second predetermined time has elapsed, it is determined whether the first mode or not in a step S141. Although an illustration is omitted, in the memory 56a of the microcomputer 56, the mode identifying flag is stored. The mode identifying flag is a flag for determining whether the first mode or the second mode and is made up of a one bit register. In the first mode, the mode identifying flag is turned on, and the data value “1” is registered in the register. Alternatively, in the second mode, the mode identifying flag is turned off, and a data value “0” is set to the register.

Here, the mode identifying flag is turned on when the power source of the game apparatus 10 is turned on, or when the second mode switches to the first mode, and the mode identifying flag is turned off when the first mode switches to the second mode.

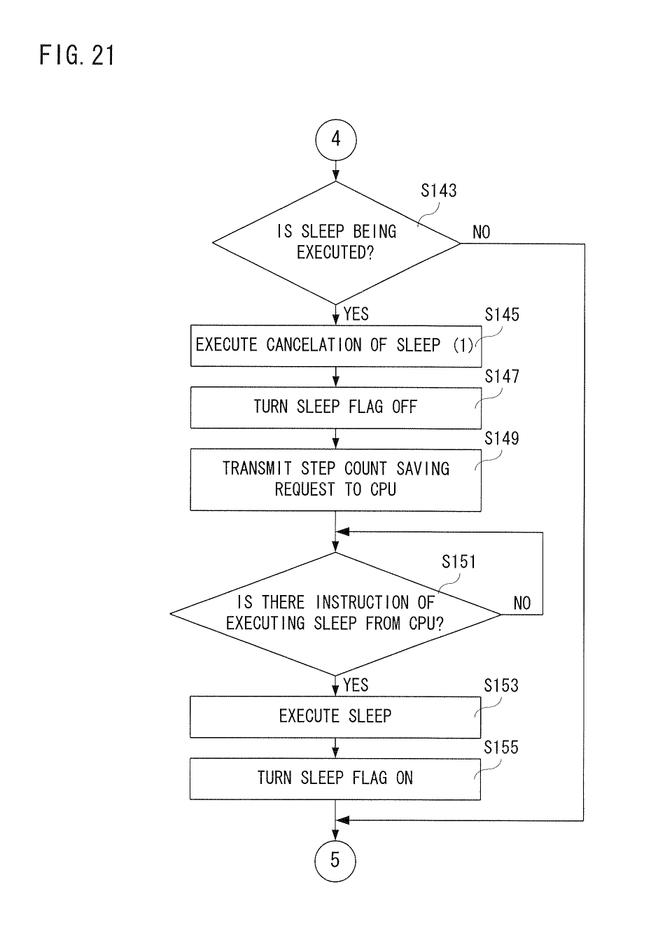

If “NO” in the step S141, that is, if the mode identifying flag is turned off, it is determined that the second mode prevails, and the process proceeds to the step S157. On the other hand, if “YES” in the step S141, that is, if the mode identifying flag is turned on, it is determined that the first mode prevails, and it is determined whether or not the sleep is being executed in a step S143 shown in FIG. 21. Here, the microcomputer 56 determines whether or not the sleep flag 604g is turned on. If “NO” in the step S143, that is, if the sleep is not being executed, the process proceeds to the step S157 as it is.

On the other hand, if “YES” in the step S143, that is, if the sleep is being executed, cancelation of the sleep (1) is executed in a step S145. Here, the game apparatus 10 is in the closed state and transmits a step count saving request to the CPU 44a as described later, and the CPU 44a merely executes step count saving processing. Accordingly, in the cancelation of the sleep (1), the microcomputer 56 boots up the CPU 44a and controls the power source management IC 52 to supply electric power to only the NAND-type flash memory 48. In a successive step S147, the sleep flag 604g is turned off, and in a step S149, a step count saving request is transmitted to the CPU 44a. That is, in the first mode, if the second predetermined time has elapsed during the sleep, the step count saving processing is executed, but in the second mode, even if the second predetermined time has elapsed during the sleep, the step count saving processing is not executed.

Succeedingly, in a step S151, it is determined whether or not there is an instruction of executing the sleep from the CPU 44a. If “NO” in the step S151, that is, if there is no instruction of executing the sleep from the CPU 44a, the process returns to the same step S151 to wait for an instruction of executing the sleep. On the other hand, if “YES” in the step S151, that is, if there is an instruction of executing the sleep from the CPU 44a, the sleep is executed in a step S153, the sleep flag 604g is turned on in a step S155, and the process proceeds to a step S157. That is, in the step S153, the microcomputer 56 stops the clock of the CPU 44a, and controls the power source management IC 52 to stop supplying electric power to the NAND-type flash memory 48, and the process returns to the sleep state.

As shown in FIG. 22, in the step S157, it is determined whether or not the cover is opened. Here, the microcomputer 56 determines whether or not an ON signal is applied from the opening and closing switch 60. If “NO” in the step S157, that is, if the cover is not opened, the process returns to the step S139 shown in FIG. 20. On the other hand, if “YES” in the step S157, that is, if the cover is opened, it is determined whether or not the sleep is being executed in a step S159.

If “NO” in the step S159, the process proceeds to a step S167 as it is. On the other hand, if “YES” in the step S159, cancellation of the sleep (2) is executed in a step S161. Here, the cover of the game apparatus 10 is opened, and therefore, in the cancellation of the sleep (2), the microcomputer 56 boots up the CPU 44a, and controls the power source management IC 52 to supply electric power to all of the components. Succeedingly, a cancellation of the sleep is instructed to the CPU 44a in a step S163, the sleep flag 604g is turned off in a step S165, and then, the process proceeds to the step S167.

In the step S167, the cover opening information is transmitted to the CPU 44a. Then, in a step S169, it is determined whether or not there is an instruction of stopping counting step counts from the CPU 44a. If “NO” in the step S169, that is, if there is no instruction of stopping counting step counts from the CPU 44a, the process returns to the same step S169 to wait for an instruction of stopping counting the step counts. On the other hand, if “YES” in the step S169, that is, if there is an instruction of stopping counting step counts from the CPU 44a, counting the step counts is ended in a step S171, and the process proceeds to a step S173 shown in FIG. 23. In the step S171, the microcomputer 56 ends the task of the step count counting processing.

As shown in FIG. 23, in the step S173, it is determined whether or not there is an instruction of turning the power source off. That is, the microcomputer 56 determines whether or not the power button 24k is turned on. If “NO” in the step S173, that is, if there is no instruction of turning the power source off, the process returns to the step S123 shown in FIG. 19. On the other hand, if “YES” in the step S173, that is, if there is an instruction of turning the power source off, power-off information is transmitted to the CPU 44a in a step S175, and it is determined whether or not there is an instruction of executing a power-off from the CPU 44a in a step S177.

If “NO” in the step S177, that is, if there is no instruction of executing a power-off from the CPU 44a, the process returns to the same step S177 to wait for an instruction of executing a power-off. On the other hand, if “YES” in the step S177, that is, if there is an instruction of executing a power-off from the CPU 44a, the power source of the game apparatus 10 is turned off in a step S179, and the entire processing is ended. In the step S179, the microcomputer 56 controls the power source management IC 52 to stop supplying electric power to all the components except for the power source management IC 52 and the microcomputer 56.

Although omitted in FIG. 19-FIG. 23, if “YES” in the step S123, the microcomputer 56 controls the power source management IC 52 to stop supplying electric power to the stereoscopic LCD 12 and lower LCD 14. Furthermore, if “YES” in the step S157, the microcomputer 56 controls the power source management IC 52 to supply electric power to the stereoscopic LCD 12 and the lower LCD 14 irrespective of whether the sleep or not.

FIG. 24 is a flowchart showing the step count counting processing by the microcomputer 56. As shown in FIG. 24, when the microcomputer 56 starts the step count counting processing, it determines whether or not an acceleration more than the predetermined value is detected in a step S201. That is, the microcomputer 56 determines whether or not an acceleration indicated by an acceleration signal from the acceleration sensor 54 is equal to or more than the predetermined value.

If “NO” in the step S201, that is, if an acceleration being equal to or more than the predetermined value is not detected, the process proceeds to a step S213 as it is. On the other hand, if “YES” in the step S201, that is, if an acceleration being equal to or more than a predetermined value is detected, it is determined whether or not the advanced minute and second has come in a step S203. Here, the microcomputer 56 determines whether or not the memory area of the step count data (650a, 650b, . . . ) is to be changed on the basis of the current time counted by the RTC 56a, the offset indicated by the offset data 604b, the advanced minute and second indicated by the advanced minute and second data 604c and the latest step count date and time indicated by the latest step count date data 604e. If “NO” in the step S203, that is, if the advanced minute and second has not come, the process proceeds to a step S209 as it is. On the other hand, if “YES” in the step S203, that is, if the advanced minute and second has come, regarding the current time counted by the RTC 56a as a latest step count date and time, the corresponding latest step count date data 604e is written to the memory 56b in a step S205. That is, the latest step count date data 604e is updated. In a next step S207, the memory area of the step count data is changed, and the process proceeds to the step S209.

In the step S209, the step counts corresponding to the step count data (650a, 650b, . . . ) stored in the current memory area is added by one. At this time, the microcomputer 56 determines that the memory area indicated by the latest step count memory area identifying data 604d is judged as a current memory area. Here, in a case that the step count data is not stored in the current memory area, the step count data about which the step count is 1 is stored in the current memory area.

In a succeeding step S211, the number of accumulative step counts is added by one. That is, the microcomputer 56 adds the number of accumulative step counts indicated by the accumulative step count data 604f by one. Then, in the step S213, it is determined whether or not counting step counts is to be ended. As described above, when there is an instruction of stopping counting step counts from the CPU 44a, the microcomputer 56 ends the counting of the step counts.

If “NO” in the step S213, that is, if counting the step count is not to be ended, the process returns to the step S201 as it is to continue counting the step counts. On the other hand, if “YES” in the step S213, that is, if counting the step counts is to be ended, the step count counting processing is ended.

According to this embodiment, in a case that the power source of the game apparatus is turned on, and the first mode is set, the step count data stored in the memory within the microcomputer is saved in the NAND-type flash memory at a predetermined timing, such as every time that the second predetermined time has elapsed, before a switch from the first mode to the second mode is made, and before the power source is turned off irrespective of whether the sleep state or not. Accordingly, it is possible to prevent the memory area of the memory within the microcomputer from becoming full and being incapable of storing the step count. That is, it is possible to simply and easily implement saving of the step counts for a long time without the need of an operation by the user or the player.

Additionally, in this embodiment, in a case that the game apparatus is not in the sleep state, whether or not the second predetermined time has elapsed is determined on the basis of the count value by the timer provided within the CPU, but in such a case as well, whether or not the second predetermined time has elapsed may be determined on the basis of the count value by the RTC.

Furthermore, in this embodiment, the step count data stored in the memory within the microcomputer is saved in the NAND-type flash memory at the predetermined timing, such as when the second predetermined time has elapsed, before a switch from the first mode to the second mode is made (before rebooting the game apparatus) and before the power source is turned off, but there is no need of being restricted thereto.

More specifically, the step count saving processing may be executed before the sleep is executed in the first mode, when the sleep is canceled in the first mode, and when the step count data memory area of the memory within the microcomputer becomes full in the first mode, and so forth. Alternatively, when the power source is turned off, the step count saving processing may not be executed. Here, whether the power of the game apparatus is turned off or the game apparatus is rebooted is selected (determined) by the CPU.

Furthermore, there is no need of being restricted to the configuration of the game apparatus shown in this embodiment. The LCD may be provided by one, or a touch panel need not be provided. Alternatively, touch panels may be provided on both of the LCDs. Furthermore, no camera may be provided, or four or more cameras may be provided. Of course, one or two cameras may be appropriate. In addition, two stereoscopic LCDs may be provided, or conversely, two LCD incapable of a stereoscopic display may be provided. In addition, the various buttons and the analog pads may partly be omitted, and arrangement positions thereof may arbitrarily be changed.

In addition, in this embodiment, as one example of the information processing apparatus, a portable game apparatus is described, but there is no need of being restricted thereto. An information processing apparatus having two or more memories different in a memory capacity and a function of detecting step counts would be applied to other information processing apparatuses, such as a cellular phone, a PDA.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An information processing apparatus, comprising:
a step count detector which detects step counts;
a step count storage which stores step count data corresponding to the step counts detected by said step count detector in a first memory; and
a saver which automatically reads the step count data stored in said first memory at a predetermined timing and saves the same in a second memory different from said first memory.

2. An information processing apparatus according to claim 1, further comprising:
a state switcher which switches said information processing apparatus between an unused state and a used state, wherein
said step count detector detects step counts at least in said unused state, and
said saver automatically reads the step count data stored in said first memory at the predetermined timing and stores the same in said second memory at least in said unused state.

3. An information processing apparatus according to claim 2, wherein
said step count detector detects step counts in said unused state, and does not detect step counts in said used state.

4. An information processing apparatus according to claim 2, wherein
said state switcher switches between a power saving mode and a normal mode,
said step count detector detects step counts at least in said power saving mode, and
said saver automatically reads the step count data stored in said first memory and saves the same in said second memory after a temporary switch to said normal mode at a predetermined timing during said power saving mode.

5. An information processing apparatus according to claim 4, wherein
said step count detector detects step counts in said power saving mode, and does not detects step counts in said normal mode.

6. An information processing apparatus according to claim 4, wherein
said saver automatically reads the step count data stored in said first memory at the predetermined timing and saves the same in said second memory in said normal mode.

7. An information processing apparatus according to claim 2, wherein
said state switcher switches said saver between an activated state and an inactivated state,
said step count detector detects step counts when said saver is at least in said inactivated state, and
said saver automatically reads the step count data stored in said first memory and saves the same in said second memory after a temporary switch to said activated state by said state switcher at the predetermined timing during said inactivated state.

8. An information processing apparatus according to claim 7, wherein
said step count detector detects steps counts when said saver is in the inactivated state, and does not detect step counts when said saver is in the activated state.

9. An information processing apparatus according to claim 7, wherein
said saver automatically reads the step count data stored in said first memory at the predetermined timing and saves the same in said second memory when it is in said activated state.

10. An information processing apparatus according to claim 1, wherein
said predetermined timing is every lapse of a predetermined time.

11. An information processing apparatus according to claim 10, wherein
a first predetermined timing is when said predetermined time has elapsed from a time being a reference.

12. An information processing apparatus according to claim 10, further comprising a selector which selects between a power-off and a reboot, wherein
said predetermined timing is a timing when a power-off or a reboot is selected by said selector.

13. An information processing apparatus according to claim 1, wherein
said first memory has a memory area for storing step count data for a short time, and
said second memory has a memory area of a high capacity capable of recording step count data for a longer time than the memory area of said first memory.

14. An information processing apparatus according to claim 1, further comprising:
a mode switcher which switches a first mode for executing a program for said information processing apparatus and a second mode for executing a program for another information processing apparatus, wherein
said saver automatically reads the step count data stored in said first memory at said predetermined timing and stores the same in said second memory in said first mode, and does not save the step count data stored in said first memory in said second memory in said second mode.

15. An information processing apparatus according to claim 14, wherein
said saver saves step count data that is stored in said first memory in said second mode in said second memory at said predetermined timing after said second mode switches to said first mode by said mode switcher.

16. A storage medium storing an information processing program, said information processing program causes a computer to function as:
a step count detector which detects step counts;
a step count storage which stores step count data corresponding to the step counts detected by said step count detector in a first memory; and
a saver which automatically reads the step count data stored in said first memory at a predetermined timing and saves the same in a second memory different from said first memory.

17. An information processing method, wherein
a computer
(a) detects step counts,
(b) stores step count data corresponding to the step counts detected by said step (a) in a first memory, and
(c) automatically reads the step count data stored in said first memory at a predetermined timing and saves the same in a second memory different from said first memory.

18. An information processing apparatus comprising:
a microcomputer which detects step counts and stores step count data corresponding to the detected step counts in a first memory; and
a CPU which reads the step count data stored in said first memory and saves the same in a second memory different from said first memory; wherein
the CPU automatically reads the step count data stored in the first memory at a predetermined timing and saves the same in the second memory and stops in response to a request from the microcomputer during running, and boots up in response to a request from the microcomputer, reads the step count data stored in the first memory and saves the same in the second memory during a stop.

19. A information processing method of an information processing apparatus, comprising:
a microcomputer which detects step counts and stores step count data corresponding to the detected step counts in a first memory; and
a CPU which reads the step count data stored in said first memory and saves the same in a second memory different from said first memory; wherein
wherein the CPU automatically reads the step count data stored in the first memory at a predetermined timing and saves the same in the second memory and stops in response to a request from the microcomputer during running, and boots up in response to a request from the microcomputer, reads the step count data stored in the first memory and saves the same in the second memory during a stop.
